(19) United States
(12) Patent Application Publication
(10) Pub. No.: US 2023/0102563 A1
(43) Pub. Date: Mar. 30, 2023

(54) TECHNIQUES FOR CROSS-CARRIER SCHEDULING FROM A SECONDARY CELL TO A PRIMARY CELL

(71) Applicant: QUALCOMM Incorporated, San Diego, CA (US)

(72) Inventors: Kazuki Takeda, Tokyo (JP); Mostafa Khoshnevisan, San Diego, CA (US)

(21) Appl. No.: 17/889,181

(22) Filed: Aug. 16, 2022

Related U.S. Application Data
(60) Provisional application No. 63/251,003, filed on Sep. 30, 2021.
(60) Provisional application No. 63/255,004, filed on Oct. 12, 2021.

(51) Int. Cl. H04W 72/12; H04W 24/08; H04W 72/14

(52) U.S. Cl. CPC H04W 72/1263; H04W 24/08; H04W 72/14

(57) ABSTRACT

Methods, systems, and devices for wireless communications are described. In some systems, a user equipment (UE) may communicate with a base station on multiple serving cells, such as on a primary cell (PCell) and on one or more secondary cells (SCells). In some aspects, the UE may receive an indication of various search space (SS) sets associated with the serving cells on which the UE may communicate with the base station and may receive an indication that an SCell is configured as a scheduling cell for a PCell. The UE 115 may identify an SS set on the SCell that is linked to an SS set on the PCell and may monitor the linked SS set on the SCell for cross-carrier scheduling to the PCell. The UE 115 also may monitor an (unlinked) SS set on the PCell for self-scheduling on the PCell.

### CROSS REFERENCE

The present Application for Patent claims the benefit of U.S. Provisional Patent Application No. 63/255,004 by TAKEDA et al., entitled “TECHNIQUES FOR CROSS-CARRIER SCHEDULING FROM A SECONDARY CELL TO A PRIMARY CELL WITH SEPARATE GRANT CONFIGURATIONS,” filed Oct. 12, 2021, and the benefit of U.S. Provisional Patent Application No. 63/251,003 by TAKEDA et al., entitled “TECHNIQUES FOR CROSS-CARRIER SCHEDULING FROM A SECONDARY CELL TO A PRIMARY CELL,” filed Sep. 30, 2021, each of which is assigned to the assignee hereof, and each of which is expressly incorporated by reference herein.

### FIELD OF TECHNOLOGY

The following relates to wireless communications, including techniques for cross-carrier scheduling from a secondary cell (SCell) to a primary cell (PCell).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some systems, a UE may communicate with one or more base stations on one or more serving cells. For example, the UE may communicate with the base station on a primary cell (PCell) and may communicate with the base station on a secondary cell (SCell).

### SUMMARY

The described techniques relate to improved methods, systems, devices, and apparatuses that support techniques for cross-carrier scheduling from a secondary cell (SCell) to a primary cell (PCell) with separate grant configurations. Generally, the described techniques provide for monitoring a PCell over a first search space (SS) set for first control messages scheduling communication for the PCell (e.g., for self-scheduling on the PCell) and for monitoring an SCell over a second SS set for second control messages scheduling communication for the PCell (e.g., for cross-carrier scheduling from the SCell to the PCell). For example, a user equipment (UE) may receive, from a base station, one or more control messages identifying or otherwise configuring one or more SS sets including the first SS set for the PCell and identifying or otherwise configuring one or more SS sets including the second SS set for the SCell and indicating that the second SS set is linked to an SS set of the PCell (e.g., a third SS set) for cross-carrier scheduling of the PCell by the SCell. In some implementations, and based on the linking of the second SS set for cross-carrier scheduling of the PCell by the SCell, the UE may refrain from monitoring over the linked SS set (e.g., the third SS set) on the PCell. In some other implementations, and based on the linking of the second SS set for cross-carrier scheduling of the PCell by the SCell, the UE may selectively monitor (e.g., monitor or suppress monitoring) over the linked SS set (e.g., the third SS set) on the PCell in accordance with satisfaction of a condition.

In some implementations, the UE may further receive, via the one or more control messages, a parameter indicating whether the UE is to monitor for uplink grants, downlink grants, or both over SS sets for each cell. In other words, for example, the UE may receive a first parameter indicating whether to monitor for uplink grants, downlink grants, or both over SS sets for the PCell and a second parameter indicating whether to monitor for uplink grants, downlink grants, or both over SS sets for the SCell.

A method for wireless communication at a UE is described. The method may include receiving at least one control message identifying a first SS set and a third SS set for a first cell and a second SS set for a second cell, where the third SS set for the first cell is linked, for cross-carrier scheduling of the first cell by the second cell, with the second SS set for the second cell, monitoring the first cell over the first SS set for first control messages associated with scheduling of communication for the first cell, monitoring the second cell over the second SS set for second control messages associated with scheduling of communication for the first cell, where monitoring the second cell over the second SS set is based on the linking of the second SS set with the third SS set, and communicating over the first cell based on the first control messages or the second control messages.

An apparatus for wireless communication at a UE is described. The apparatus may include a processor, memory coupled with the processor, and instructions stored in the memory. The instructions may be executable by the processor to cause the apparatus to receive at least one control message identifying a first SS set and a third SS set for a first cell and a second SS set for a second cell, where the third SS set for the first cell is linked, for cross-carrier scheduling of the first cell by the second cell, with the second SS set for the second cell, monitor the first cell over the first SS set for first control messages associated with scheduling of communication for the first cell, monitor the second cell over the second SS set for second control messages associated with scheduling of communication for the first cell, where monitoring the second cell over the second SS set is based on the linking of the second SS set with the third SS set, and communicate over the first cell based on the first control messages or the second control messages.

Another apparatus for wireless communication at a UE is described. The apparatus may include means for receiving at least one control message identifying a first SS set and a third SS set for a first cell and a second SS set for a second cell, where the third SS set for the first cell is linked, for cross-carrier scheduling of the first cell by the second cell, with the second SS set for the second cell, means for monitoring the first cell over the first SS set for first control messages associated with scheduling of communication for the first cell, means for monitoring the second cell over the second SS set for second control messages associated with scheduling of communication for the first cell, where monitoring the second cell over the second SS set is based on the linking of the second SS set with the third SS set, and means for communicating over the first cell based on the first control messages or the second control messages.

A non-transitory computer-readable medium storing code for wireless communication at a UE is described. The code may include instructions executable by a processor to receive at least one control message identifying a first SS set and a third SS set for a first cell and a second SS set for a second cell, where the third SS set for the first cell is linked, for cross-carrier scheduling of the first cell by the second cell, with the second SS set for the second cell, monitor the first cell over the first SS set for first control messages associated with scheduling of communication for the first cell, monitor the second cell over the second SS set for second control messages associated with scheduling of communication for the first cell, where monitoring the second cell over the second SS set is based on the linking of the second SS set with the third SS set, and communicate over the first cell based on the first control messages or the second control messages.

Some examples of the method, apparatuses, and non-transitory computer-readable medium described herein may further include operations, features, means, or instructions for suppressing monitoring of the first cell over the third SS set that may be linked with the second SS set for cross-carrier scheduling based on the linking of the second SS set with the third SS set.

In some examples of the method, apparatuses, and non-transitory computer-readable medium described herein, receiving the at least one control message may include receiving an indication that the second search space set and the third search space set have a same search space identifier, where the linking between the second search space set with the third search space set is based on the second search space set and the third search space set having the same search space identifier, and where suppressing the monitoring of the first cell over the third search space set is based on the second search space set and the third search space set having the same search space identifier.

Some examples of the method, apparatuses, and non-transitory computer-readable medium described herein may further include operations, features, means, or instructions for monitoring the first cell over the third SS set that may be linked with the second SS set for cross-carrier scheduling if a condition associated with the third SS set may be satisfied and suppressing monitoring of the first cell over the third SS set that may be linked with the second SS set if the condition with the third SS set may be not satisfied.

Some examples of the method, apparatuses, and non-transitory computer-readable medium described herein may further include operations, features, means, or instructions for receiving, via the at least one control message, an indication of a control resource set ID associated with the third SS set, where receiving the indication of the control resource set ID associated with the third SS set satisfies the condition.

Some examples of the method, apparatuses, and non-transitory computer-readable medium described herein may further include operations, features, means, or instructions for receiving, via the at least one control message, an indication of a type of the third SS set, where receiving the indication of the type of the third SS set satisfies the condition.

Some examples of the method, apparatuses, and non-transitory computer-readable medium described herein may further include operations, features, means, or instructions for receiving, via the at least one control message, a bitmap indicating a set of symbols during which to monitor over the third SS set, where receiving the bitmap indicating the set of symbols during which to monitor over the third SS set satisfies the condition.

Some examples of the method, apparatuses, and non-transitory computer-readable medium described herein may further include operations, features, means, or instructions for receiving, via the at least one control message, a parameter exclusively configured for indicating whether to monitor over the third SS set.

Some examples of the method, apparatuses, and non-transitory computer-readable medium described herein may further include operations, features, means, or instructions for monitoring the first cell over the third SS set that may be linked with the second SS set for cross-carrier scheduling based on the parameter indicating that the UE may be to monitor over the third SS set and suppressing monitoring of the first cell over the third SS set that may be linked with the second SS set for cross-carrier scheduling based on the parameter indicating that the UE may be to refrain from monitoring over the third SS set.

In some examples of the method, apparatuses, and non-transitory computer-readable medium described herein, monitoring the second cell over the second SS set for the second control messages associated with scheduling of communication for the first cell may include operations, features, means, or instructions for monitoring over a quantity of physical downlink control channel (PDCCH) candidates based on the at least one control message identifying the third SS set with the quantity of PDCCH candidates and the linking of the second SS set with the third SS set.

In some examples of the method, apparatuses, and non-transitory computer-readable medium described herein, communicating on at least the first cell based on the first control messages or the second control messages may include operations, features, means, or instructions for receiving a downlink shared channel message based on scheduling information in the first control messages or the second control messages.

Some examples of the method, apparatuses, and non-transitory computer-readable medium described herein may further include operations, features, means, or instructions for receiving a control message indicating that the second cell may be a scheduling cell for the first cell, where the first cell includes a PCell or a PSCell and the second cell includes an SCell.

A method for wireless communication at a base station is described. The method may include transmitting, to a UE, at least one control message identifying a first SS set and a third SS set for a first cell and a second SS set for a second cell, where the third SS set for the first cell is linked, for cross-carrier scheduling of the first cell by the second cell, with the second SS set for the second cell, transmitting, to the UE on the first cell over the first SS set, first control messages associated with scheduling of communication for the first cell, transmitting, to the UE on the second cell over the second SS set, second control messages associated with scheduling of communication for the first cell, where transmitting the second control messages on the second cell over the second SS set is based on the linking of the second SS set with the third SS set, and communicating with the UE on at least the first cell based on the first control messages or the second control messages.

An apparatus for wireless communication at a base station is described. The apparatus may include a processor, memory coupled with the processor, and instructions stored in the memory. The instructions may be executable by the processor to cause the apparatus to transmit, to a UE, at least one control message identifying a first SS set and a third SS set for a first cell and a second SS set for a second cell, where the third SS set for the first cell is linked, for cross-carrier scheduling of the first cell by the second cell, with the second SS set for the second cell, transmit, to the UE on the first cell over the first SS set, first control messages associated with scheduling of communication for the first cell, transmit, to the UE on the second cell over the second SS set, second control messages associated with scheduling of communication for the first cell, where transmitting the second control messages on the second cell over the second SS set is based on the linking of the second SS set with the third SS set, and communicate with the UE on at least the first cell based on the first control messages or the second control messages.

Another apparatus for wireless communication at a base station is described. The apparatus may include means for transmitting, to a UE, at least one control message identifying a first SS set and a third SS set for a first cell and a second SS set for a second cell, where the third SS set for the first cell is linked, for cross-carrier scheduling of the first cell by the second cell, with the second SS set for the second cell, means for transmitting, to the UE on the first cell over the first SS set, first control messages associated with scheduling of communication for the first cell, means for transmitting, to the UE on the second cell over the second SS set, second control messages associated with scheduling of communication for the first cell, where transmitting the second control messages on the second cell over the second SS set is based on the linking of the second SS set with the third SS set, and means for communicating with the UE on at least the first cell based on the first control messages or the second control messages.

A non-transitory computer-readable medium storing code for wireless communication at a base station is described. The code may include instructions executable by a processor to transmit, to a UE, at least one control message identifying a first SS set and a third SS set for a first cell and a second SS set for a second cell, where the third SS set for the first cell is linked, for cross-carrier scheduling of the first cell by the second cell, with the second SS set for the second cell, transmit, to the UE on the first cell over the first SS set, first control messages associated with scheduling of communication for the first cell, transmit, to the UE on the second cell over the second SS set, second control messages associated with scheduling of communication for the first cell, where transmitting the second control messages on the second cell over the second SS set is based on the linking of the second SS set with the third SS set, and communicate with the UE on at least the first cell based on the first control messages or the second control messages.

Some examples of the method, apparatuses, and non-transitory computer-readable medium described herein may further include operations, features, means, or instructions for suppressing transmitting control messages to the UE on the first cell over the third SS set that may be linked with the second SS set for cross-carrier scheduling based on the linking of the second SS set with the third SS set.

In some examples of the method, apparatuses, and non-transitory computer-readable medium described herein, transmitting the at least one control message may include transmitting an indication that the second search space set and the third search space set have a same search space identifier, where the linking between the second search space set with the third search space set is based on the second search space set and the third search space set having the same search space identifier, and where suppressing the transmitting of the control messages on the first cell over the third search space set is based on the second search space set and the third search space set having the same search space identifier

Some examples of the method, apparatuses, and non-transitory computer-readable medium described herein may further include operations, features, means, or instructions for transmitting one or more control messages to the UE on the first cell over the third SS set that may be linked with the second SS set for cross-carrier scheduling if a condition associated with the third SS set may be satisfied and suppressing transmitting the one or more control messages to the UE on the first cell over the third SS set that may be linked with the second SS set for cross-carrier scheduling if the condition associated with the third SS set may be not satisfied.

Some examples of the method, apparatuses, and non-transitory computer-readable medium described herein may further include operations, features, means, or instructions for transmitting, via the at least one control message, an indication of a control resource set ID associated with the third SS set, where transmitting the indication of the control resource set ID associated with the third SS set satisfies the condition.

Some examples of the method, apparatuses, and non-transitory computer-readable medium described herein may further include operations, features, means, or instructions for transmitting, via the at least one control message, an indication of a type of the third SS set, where transmitting the indication of the type of the third SS set satisfies the condition.

Some examples of the method, apparatuses, and non-transitory computer-readable medium described herein may further include operations, features, means, or instructions for transmitting, via the at least one control message, a bitmap indicating a set of symbols during which the UE may be to monitor over the third SS set, where transmitting the bitmap indicating the set of symbols during which the UE may be to monitor over the third SS set satisfies the condition.

Some examples of the method, apparatuses, and non-transitory computer-readable medium described herein may further include operations, features, means, or instructions for transmitting, via the at least one control message, a parameter exclusively configured for indicating whether the UE may be to monitor over the third SS set.

Some examples of the method, apparatuses, and non-transitory computer-readable medium described herein may further include operations, features, means, or instructions for transmitting on the first cell over the third SS set that may be linked with the second SS set for cross-carrier scheduling based on the parameter indicating that the UE may be to monitor over the third SS set and suppressing transmitting on the first cell over the third SS set that may be linked with the second SS set for cross-carrier scheduling based on the parameter indicating that the UE may be to refrain from monitoring over the third SS set.

In some examples of the method, apparatuses, and non-transitory computer-readable medium described herein, transmitting the second control messages to the UE on the second cell over the second SS set may include operations, features, means, or instructions for transmitting over at least a subset of a quantity of PDCCH candidates, the quantity of PDCCH candidates based on the at least one control message identifying the third SS set with the quantity of PDCCH candidates and the linking of the second SS set with the third SS set.

In some examples of the method, apparatuses, and non-transitory computer-readable medium described herein, communicating with the UE on at least the first cell based on the first control messages or the second control messages may include operations, features, means, or instructions for transmitting a downlink shared channel message based on scheduling information in the first control messages or the second control messages.

Some examples of the method, apparatuses, and non-transitory computer-readable medium described herein may further include operations, features, means, or instructions for transmitting a control message indicating that the second cell may be a scheduling cell for the first cell, where the first cell includes a PCell or a PSCell and the second cell includes an SCell.

A method for wireless communication at a UE is described. The method may include receiving one or more control messages identifying a first SS set for a first cell and a second SS set for a second cell, where the first SS set for the first cell is linked, for cross-carrier scheduling of the first cell by the second cell, with the second SS set for the second cell, and where the one or more control messages include a first parameter indicating whether to monitor for uplink grants, downlink grants, or both, for the first cell and include a second parameter indicating whether to monitor for uplink grants, downlink grants, or both, for the second cell, monitoring, based on the first parameter and the second parameter, the first cell over one of the first SS set or a third SS set for one of the uplink grants or the downlink grants and the second cell over the second SS set for the other one of the uplink grants or the downlink grants, and communicating over the first cell based on the uplink grants or the downlink grants, or both.

An apparatus for wireless communication at a UE is described. The apparatus may include a processor, memory coupled with the processor, and instructions stored in the memory. The instructions may be executable by the processor to cause the apparatus to receive one or more control messages identifying a first SS set for a first cell and a second SS set for a second cell, where the first SS set for the first cell is linked, for cross-carrier scheduling of the first cell by the second cell, with the second SS set for the second cell, and where the one or more control messages include a first parameter indicating whether to monitor for uplink grants, downlink grants, or both, for the first cell and include a second parameter indicating whether to monitor for uplink grants, downlink grants, or both, for the second cell, monitor, based on the first parameter and the second parameter, the first cell over one of the first SS set or a third SS set for one of the uplink grants or the downlink grants and the second cell over the second SS set for the other one of the uplink grants or the downlink grants, and communicate over the first cell based on the uplink grants or the downlink grants, or both.

Another apparatus for wireless communication at a UE is described. The apparatus may include means for receiving one or more control messages identifying a first SS set for a first cell and a second SS set for a second cell, where the first SS set for the first cell is linked, for cross-carrier scheduling of the first cell by the second cell, with the second SS set for the second cell, and where the one or more control messages include a first parameter indicating whether to monitor for uplink grants, downlink grants, or both, for the first cell and include a second parameter indicating whether to monitor for uplink grants, downlink grants, or both, for the second cell, means for monitoring, based on the first parameter and the second parameter, the first cell over one of the first SS set or a third SS set for one of the uplink grants or the downlink grants and the second cell over the second SS set for the other one of the uplink grants or the downlink grants, and means for communicating over the first cell based on the uplink grants or the downlink grants, or both.

A non-transitory computer-readable medium storing code for wireless communication at a UE is described. The code may include instructions executable by a processor to receive one or more control messages identifying a first SS set for a first cell and a second SS set for a second cell, where the first SS set for the first cell is linked, for cross-carrier scheduling of the first cell by the second cell, with the second SS set for the second cell, and where the one or more control messages include a first parameter indicating whether to monitor for uplink grants, downlink grants, or both, for the first cell and include a second parameter indicating whether to monitor for uplink grants, downlink grants, or both, for the second cell, monitor, based on the first parameter and the second parameter, the first cell over one of the first SS set or a third SS set for one of the uplink grants or the downlink grants and the second cell over the second SS set for the other one of the uplink grants or the downlink grants, and communicate over the first cell based on the uplink grants or the downlink grants, or both.

In some examples of the method, apparatuses, and non-transitory computer-readable medium described herein, the monitoring may include operations, features, means, or instructions for monitoring the first cell over the first SS set for the first subset of the set of control information formats and the second cell over the second SS set for the second subset of the set of control information formats.

In some examples of the method, apparatuses, and non-transitory computer-readable medium described herein, the monitoring may include operations, features, means, or instructions for monitoring the first cell over the third SS set for the first subset of the set of control information formats and the second cell over the second SS set for the second subset of the set of control information formats.

In some examples of the method, apparatuses, and non-transitory computer-readable medium described herein, a number of decoding candidates for monitoring for the second cell over the second SS set may be indicated in a third parameter of a configuration for the first SS set.

In some examples of the method, apparatuses, and non-transitory computer-readable medium described herein, the monitoring may include operations, features, means, or instructions for monitoring the first cell over the first SS set for a first subset of a set of control information formats and the second cell over the second SS set for a second subset of the set of control information formats.

Some examples of the method, apparatuses, and non-transitory computer-readable medium described herein may further include operations, features, means, or instructions for transmitting, to a base station, an indication that a capability of the UE may be associated with monitoring of the first cell for both the uplink grants and the downlink grants and the second cell for both the uplink grants and the downlink grants over non-overlapping monitoring occasions, where the monitoring includes and monitoring the first cell over the first SS set for the one of the uplink grants or the downlink grants in a first set of monitoring occasions and the second cell over the second SS set for the other one of the uplink grants or the downlink grants in a second set of monitoring occasions, where the first set of monitoring occasions overlap in time with the second set of monitoring occasions.

In some examples of the method, apparatuses, and non-transitory computer-readable medium described herein, communicating on at least the first cell based on the uplink grants or the downlink grants, or both may include operations, features, means, or instructions for transmitting an uplink data message based on first scheduling information in the uplink grants and receiving a downlink data message based on second scheduling information in the downlink grants.

Some examples of the method, apparatuses, and non-transitory computer-readable medium described herein may further include operations, features, means, or instructions for receiving a control message indicating that the second cell may be a scheduling cell for the first cell, where the first cell includes a PCell or a primary secondary cell (PSCell) and the second cell includes an SCell.

A method for wireless communication at a base station is described. The method may include transmitting, to a UE, one or more control messages identifying a first SS set for a first cell and a second SS set for a second cell, where the first SS set for the first cell is linked, for cross-carrier scheduling of the first cell by the second cell, with the second SS set for the second cell, and where the one or more control messages include a first parameter indicating whether to monitor for uplink grants, downlink grants, or both, for the first cell and include a second parameter indicating whether to monitor for uplink grants, downlink grants, or both, for the second cell, transmitting, to the UE on the first cell over one of the first SS set or a third SS set, one of the uplink grants or the downlink grants in accordance with the first parameter and, to the UE on the second cell over the second SS set, the other one of the uplink grants or the downlink grants in accordance with the second parameter, and communicating with the UE on at least the first cell based on the uplink grants or the downlink grants, or both.

An apparatus for wireless communication at a base station is described. The apparatus may include a processor, memory coupled with the processor, and instructions stored in the memory. The instructions may be executable by the processor to cause the apparatus to transmit, to a UE, one or more control messages identifying a first SS set for a first cell and a second SS set for a second cell, where the first SS set for the first cell is linked, for cross-carrier scheduling of the first cell by the second cell, with the second SS set for the second cell, and where the one or more control messages include a first parameter indicating whether to monitor for uplink grants, downlink grants, or both, for the first cell and include a second parameter indicating whether to monitor for uplink grants, downlink grants, or both, for the second cell, transmit, to the UE on the first cell over one of the first SS set or a third SS set, one of the uplink grants or the downlink grants in accordance with the first parameter and, to the UE on the second cell over the second SS set, the other one of the uplink grants or the downlink grants in accordance with the second parameter, and communicate with the UE on at least the first cell based on the uplink grants or the downlink grants, or both.

Another apparatus for wireless communication at a base station is described. The apparatus may include means for transmitting, to a UE, one or more control messages identifying a first SS set for a first cell and a second SS set for a second cell, where the first SS set for the first cell is linked, for cross-carrier scheduling of the first cell by the second cell, with the second SS set for the second cell, and where the one or more control messages include a first parameter indicating whether to monitor for uplink grants, downlink grants, or both, for the first cell and include a second parameter indicating whether to monitor for uplink grants, downlink grants, or both, for the second cell, means for transmitting, to the UE on the first cell over one of the first SS set or a third SS set, one of the uplink grants or the downlink grants in accordance with the first parameter and, to the UE on the second cell over the second SS set, the other one of the uplink grants or the downlink grants in accordance with the second parameter, and means for communicating with the UE on at least the first cell based on the uplink grants or the downlink grants, or both.

A non-transitory computer-readable medium storing code for wireless communication at a base station is described. The code may include instructions executable by a processor to transmit, to a UE, one or more control messages identifying a first SS set for a first cell and a second SS set for a second cell, where the first SS set for the first cell is linked, for cross-carrier scheduling of the first cell by the second cell, with the second SS set for the second cell, and where the one or more control messages include a first parameter indicating whether to monitor for uplink grants, downlink grants, or both, for the first cell and include a second parameter indicating whether to monitor for uplink grants, downlink grants, or both, for the second cell, transmit, to the UE on the first cell over one of the first SS set or a third SS set, one of the uplink grants or the downlink grants in accordance with the first parameter and, to the UE on the second cell over the second SS set, the other one of the uplink grants or the downlink grants in accordance with the second parameter, and communicate with the UE on at least the first cell based on the uplink grants or the downlink grants, or both.

In some examples of the method, apparatuses, and non-transitory computer-readable medium described herein, transmitting the one of the uplink grants or the downlink grants on the first cell and the other one of the uplink grants or the downlink grants on the second cell may include operations, features, means, or instructions for transmitting, on the first cell over the first SS set, first control information in accordance with the first subset of the set of control information formats and, on the second cell over the second SS set, second control information in accordance with the second subset of the set of control information formats.

In some examples of the method, apparatuses, and non-transitory computer-readable medium described herein, transmitting the one of the uplink grants or the downlink grants on the first cell and the other one of the uplink grants or the downlink grants on the second cell may include operations, features, means, or instructions for transmitting, on the first cell over the third SS set, first control information in accordance with the first subset of the set of control information formats and, on the second cell over the second SS set, second control information in accordance with the second subset of the set of control information formats.

In some examples of the method, apparatuses, and non-transitory computer-readable medium described herein, a number of decoding candidates for monitoring, by the UE, for the second cell over the second SS set may be indicated in a third parameter of a configuration for the first SS set.

In some examples of the method, apparatuses, and non-transitory computer-readable medium described herein, transmitting the one of the uplink grants or the downlink grants on the first cell and the other one of the uplink grants or the downlink grants on the second cell may include operations, features, means, or instructions for transmitting, on the first cell over the first SS set, first control information in accordance with a first subset of a set of control information formats and, the second cell over the second SS set, second control information in accordance with a second subset of the set of control information formats.

Some examples of the method, apparatuses, and non-transitory computer-readable medium described herein may further include operations, features, means, or instructions for receiving, from the UE, an indication that a capability of the UE may be associated with monitoring of the first cell for both the uplink grants and the downlink grants and the second cell for both the uplink grants and the downlink grants over non-overlapping monitoring occasions, and where transmitting the one of the uplink grants or the downlink grants on the first cell and the other one of the uplink grants or the downlink grants on the second cell includes and transmitting, on the first cell over the first SS set, the one of the uplink grants or the downlink grants in a first set of monitoring occasions and, on the second cell over the second SS set, the other one of the uplink grants or the downlink grants in a second set of monitoring occasions, where the first set of monitoring occasions overlap in time with the second set of monitoring occasions.

In some examples of the method, apparatuses, and non-transitory computer-readable medium described herein, communicating with the UE on at least the first cell based on the uplink grants or the downlink grants, or both may include operations, features, means, or instructions for receiving an uplink data message based on first scheduling information in the uplink grants and transmitting a downlink data message based on second scheduling information in the downlink grants.

Some examples of the method, apparatuses, and non-transitory computer-readable medium described herein may further include operations, features, means, or instructions for transmitting a control message indicating that the second cell may be a scheduling cell for the first cell, where the first cell includes a PCell or a PSCell and the second cell includes an SCell.

### BRIEF DESCRIPTION OF THE DRAWINGS

FIGS. 1 and 2 illustrate examples of wireless communications systems that support techniques for cross-carrier scheduling from a secondary cell (SCell) to a primary cell (PCell) in accordance with aspects of the present disclosure.

FIGS. 3 through 5 illustrate examples of cross-carrier scheduling diagrams that support techniques for cross-carrier scheduling from an SCell to a PCell in accordance with aspects of the present disclosure.

FIGS. 6 through 8 illustrate examples of communication timelines that support techniques for cross-carrier scheduling from an SCell to a PCell in accordance with aspects of the present disclosure.

FIGS. 9 and 10 illustrate examples of process flows that support techniques for cross-carrier scheduling from an SCell to a PCell in accordance with aspects of the present disclosure.

FIGS. 11 and 12 show block diagrams of devices that support techniques for cross-carrier scheduling from an SCell to a PCell in accordance with aspects of the present disclosure.

FIG. 13 shows a block diagram of a communications manager that supports techniques for cross-carrier scheduling from an SCell to a PCell in accordance with aspects of the present disclosure.

FIG. 14 shows a diagram of a system including a device that supports techniques for cross-carrier scheduling from an SCell to a PCell in accordance with aspects of the present disclosure.

FIGS. 15 and 16 show block diagrams of devices that support techniques for cross-carrier scheduling from an SCell to a PCell in accordance with aspects of the present disclosure.

FIG. 17 shows a block diagram of a communications manager that supports techniques for cross-carrier scheduling from an SCell to a PCell in accordance with aspects of the present disclosure.

FIG. 18 shows a diagram of a system including a device that supports techniques for cross-carrier scheduling from an SCell to a PCell in accordance with aspects of the present disclosure.

FIGS. 19 and 20 show flowcharts illustrating methods that support techniques for cross-carrier scheduling from an SCell to a PCell in accordance with aspects of the present disclosure.

### DETAILED DESCRIPTION

In some wireless communications systems, a user equipment (UE) may communicate with a base station (or with multiple base stations) on multiple cells or component carriers. For example, the UE may communicate with the base station on a primary cell (PCell), a primary secondary cell (PSCell) (e.g., a primary cell of a secondary cell group (SCG)), one or more secondary cells (SCells), or any combination thereof. As used herein, a P(S)Cell may refer to either a PCell or a PSCell. In some cases, the UE and the base station may support cross-carrier scheduling, according to which the base station may schedule communication for one cell on a different cell. For example, the base station may transmit one or more control messages, such as one or more downlink control information (DCI) messages, to the UE on a PCell and the one or more control messages may schedule communication between the UE and the base station on an SCell. In such examples in which the UE receives control messages on a PCell that schedule communication between the UE and the base station on the SCell, the UE may refrain from or otherwise suppress monitoring for any control messaging on the SCell (e.g., the UE may exclusively monitor for scheduling information on the scheduling cell and may refrain from monitoring on the scheduled cell).

In some systems, the UE and the base station may support cross-carrier scheduling from an SCell to a PCell, according to which the UE may receive one or more control messages on the SCell and the one or more control messages may schedule communication between the UE and the base station on the PCell. As such, the UE may sometimes exclusively monitor for scheduling information on the SCell (e.g., the scheduling cell) and may refrain from monitoring on the PCell (e.g., the scheduled cell). The base station, however, may transmit self-scheduling control messages to the UE on the PCell (e.g., messages sent on the PCell that schedule communication on the PCell) in addition to employing cross-carrier scheduling for the PCell. Accordingly, in such cases in which the base station transmits self-scheduling control messages on the PCell and employs cross-carrier scheduling for the PCell from the SCell, the UE may miss the self-scheduling control messages and, as a result, miss some scheduled communication. Further, some signaling designs have an inflexible configuration associated with a monitoring for uplink grants and downlink grants, and such an inflexible configuration may inhibit system performance.

In some implementations of the present disclosure, the UE and the base station may support cross-carrier scheduling for a PCell or a PSCell from an SCell such that the UE is able to reliably receive first control messages self-scheduling communication (e.g., control messages received on the P(S)Cell scheduling communication on the P(S)Cell) and second control messages scheduling cross-carrier communication (e.g., control messages received on the SCell scheduling communication on the P(S)Cell). In some examples, for instance, the UE may receive one or more control messages indicating that the UE is configured for cross-carrier scheduling and indicating that the SCell is a scheduling cell. The one or more control messages may further identify a first search space (SS) set and a third SS set for the P(S)Cell and a second SS set for the SCell and, in some aspects, the UE may identify a linking between the first SS set and the second SS set based on a matching SS set identifier (ID) and may monitor the SCell over the second SS set for the cross-carrier scheduling accordingly. Further, the UE may receive, via the one or more control messages, separate parameters that indicate whether the UE is to monitor for uplink grants, downlink grants, or both over SS sets for each of the P(S)Cell and the SCell. For example, the UE may receive a first parameter indicating whether the UE is to monitor for uplink grants, downlink grants, or both, over SS sets for the P(S)Cell and a second parameter indicating whether the UE is to monitor for uplink grants, downlink grants, or both over SS sets for the SCell. In some examples, the UE and a base station may leverage such separation of parameters for indicating whether to monitor for uplink grants, downlink grants, or both for each cell on which the UE and the base station communicate to schedule monitoring over SS sets for each of the cells based on whether the UE is to monitor for uplink grants, downlink grants, or both for each of the cells.

Particular aspects of the subject matter described herein may be implemented to realize one or more advantages. For example, based on supporting more reliable or more well-defined monitoring over SS sets across various serving cells in examples in which an SCell is configured as a scheduling cell for a P(S)Cell, the UE may be more likely to receive complete scheduling information from the base station (e.g., may be more likely to receive all scheduling control messages sent from the base station) and thus may more reliably transmit data to, or receive data from, the base station. Further, the UE and the base station may more efficiently use communication resources in accordance with scheduling monitoring over SS sets for each of the cells based on whether the UE is to monitor for uplink grants, downlink grants, or both for each of the cells, as the UE may be configurable to monitor different cells simultaneously for different grant types even in scenarios in which the UE is sometimes (based on a UE capability) unable to monitor different cells simultaneously for unknown grant types. As a result of such higher reliability and more efficient use of communication resources, the UE and the base station may experience greater spectral efficiency, higher data rates, greater system capacity, and higher throughput, among other benefits.

Aspects of the disclosure are initially described in the context of wireless communications systems. Aspects of the disclosure are additionally illustrated by and described with reference to cross-carrier scheduling diagrams, communication timelines, and a process flow. Aspects of the disclosure are further illustrated by and described with reference to apparatus diagrams, system diagrams, and flowcharts that relate to techniques for cross-carrier scheduling from an SCell to a PCell.

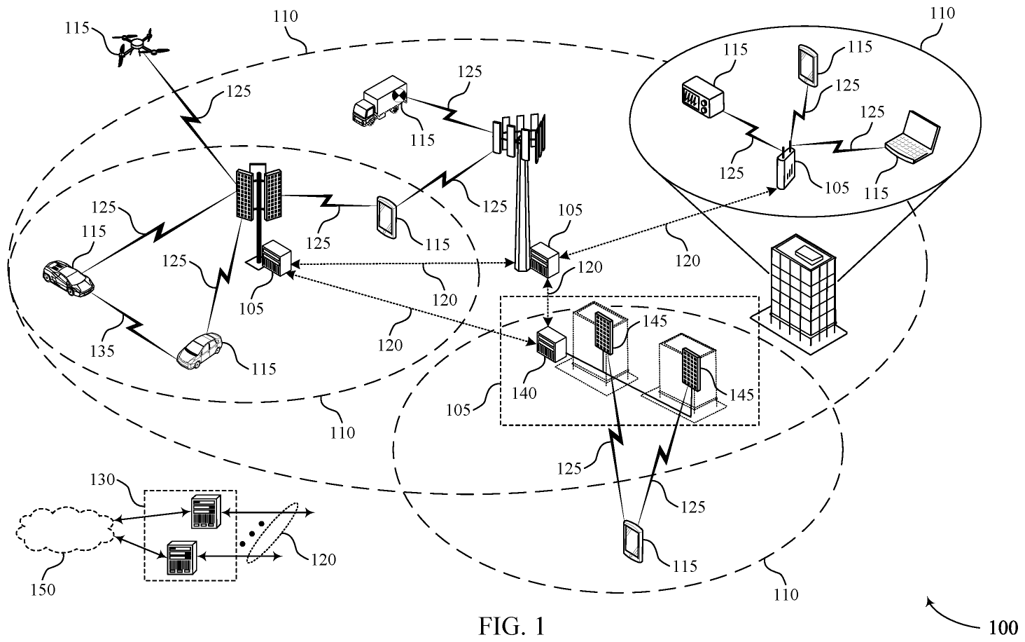

FIG. 1 illustrates an example of a wireless communications system 100 that supports techniques for cross-carrier scheduling from an SCell to a PCell in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., ΔN_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some systems, such as the wireless communications system 100, a UE 115 may communicate with a base station 105 on multiple serving cells or component carriers. For example, the UE 115 and the base station 105 may communicate on a PCell, a PSCell (e.g., for dual-connectivity deployments), or one or more SCells, or any combination thereof. In some implementations, the UE 115 and the base station 105 may support cross-carrier scheduling according to which the base station 105 may transmit, to the UE 115 on a second serving cell, scheduling information for a data message that is to be communicated on a first serving cell. In such implementations, each of the first serving cell and the second serving cell may be associated with one or more SS sets over which the UE 115 monitors that serving cell. The UE 115 and the base station 105 may determine over which SS set of the second serving cell cross-carrier scheduling control messages may be sent based on a linking between an SS set on the first cell and an SS set on the second cell.

The UE 115 may monitor the second serving cell over the linked SS set accordingly and, in some implementations, may additionally monitor the first serving cell over an SS set of the first serving cell over which the base station 105 may transmit self-scheduling control messages. In other words, for example, the UE 115 may monitor the second serving cell over the linked SS set for control messages scheduling communication between the UE 115 and the base station 105 on the first serving cell and the UE 115 may monitor the first serving cell over an SS set (which may be a different SS set than the SS set of the first serving cell which is linked to an SS set on the second serving cell) for control messages also scheduling communication between the UE 115 and the base station 105. Further, in some implementations, the UE 115 may selectively monitor over (and the base station 105 may likewise selectively transmit over) the SS set of the first serving cell which is linked to the SS set on the second serving cell in accordance with a configured rule or in accordance with a condition associated with that SS set of the first serving cell.

In some implementations, the base station 105 may also transmit, to the UE 115 via control messages, separate parameters indicating whether the UE 115 is to monitor for uplink grants, downlink grants, or both for each of the first serving cell and the second serving cell. The separate parameters may indicate which type of grant the UE 115 is to monitor for, which type of DCI the UE 115 is to monitor for, which DCI format the UE 115 is to monitor for, or over which SS set of a specific cell the UE 115 is to monitor for a specific type of DCI or DCI format. In some implementations, the base station 105 may schedule monitoring by the UE 115 based on over which cell the UE 115 is configured to monitor for one of uplink grants or downlink grants. For example, some UEs 115 (such as UEs 115 in a low power mode or that otherwise have reduced monitoring capabilities) may sometimes be unable to simultaneously monitor multiple cells if the UE 115 is unaware of whether the base station 105 is transmitting uplink grants or downlink grants over those multiple cells. As such, if the UE 115 is able to receive an indication of whether the UE 115 is expected to monitor for one of uplink grants or downlink grants on the first serving cell and is expected to monitor for the other of the uplink grants or the downlink grants on the second serving cell, the UE 115 may be able to simultaneously monitor multiple cells due to a lower decoding effort at the UE 115 associated with knowing which type of grant may be transmitted over each of the multiple cells.

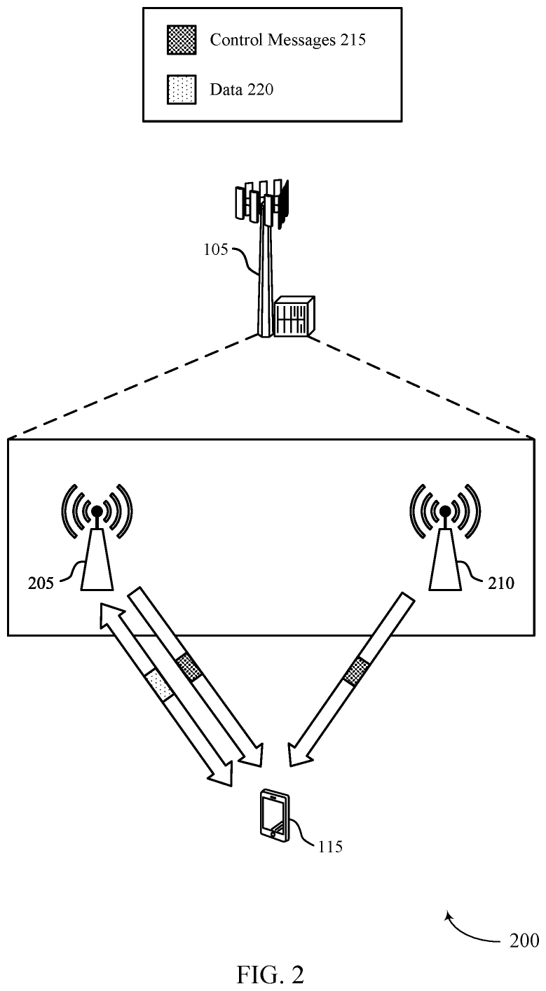

FIG. 2 illustrates an example of a wireless communications system 200 that supports techniques for cross-carrier scheduling from an SCell to a PCell in accordance with aspects of the present disclosure. The wireless communications system 200 may implement or be implemented to realize aspects of the wireless communications system 100. For example, the wireless communications system 200 illustrates communication between a UE 115 and a base station 105 on multiple cells, including a cell 205 and a cell 210, and such devices or entities may be examples of corresponding devices or entities described herein, including with reference to FIG. 1. In some implementations, the UE 115 and the base station 105 may support cross-carrier scheduling and the UE 115 may monitor both the cell 205 and the cell 210 over various SS sets for control messages 215 associated with scheduling data 220 on a scheduled cell and the monitoring may be in accordance with a configuration associated with which DCI type or format the UE 115 is expected to monitor for each of the cell 205 and the cell 210.

For example, the UE 115 and the base station 105 may exchange signaling on one or both of the cell 205 and the cell 210. In some aspects, the cell 205 and the cell 210 may be examples of different serving cells or different component carriers supported for communication between the UE 115 and the base station 105. In some aspects, the cell 205 and the cell 210 may be associated with the same base station 105. In some other aspects, the cell 205 and the cell 210 may be associated with different base stations 105. Further, the cell 205 and the cell 210 may be co-located (e.g., may be located at a same physical location) or may be distributed (e.g., may be located at different physical locations). In some aspects, the cell 205 may be an example of or may otherwise function as a PCell or a PSCell and the cell 210 may be an example of or may otherwise function as an SCell. In some aspects, the cell 205 may be referred to herein as a P(S)Cell, which may refer to one or both of a PCell and a PSCell.

In implementations in which the UE 115 and the base station 105 support cross-carrier scheduling, the base station 105 may transmit control messages 215 to the UE 115 on one of the cell 205 or the cell 210 and the control messages 215 may schedule communication between the UE 115 and the base station 105 on the other of the cell 205 or the cell 210. For example, if the UE 115 and the base station 105 configure the cell 205 as a scheduling cell and the cell 210 as a scheduled cell, the base station 105 may transmit scheduling information for communication on the cell 210 to the UE 115 over an SS set on the cell 205. Similarly, if the UE 115 and the base station 105 configure the cell 210 as a scheduling cell and the cell 205 as a scheduled cell, the base station 105 may transmit scheduling information for communication on the cell 205 to the UE 115 over an SS set on the cell 210.

Cross-carrier scheduling may differ from self-scheduling, according to which the base station 105 may transmit scheduling information for future communication on a same serving cell as for which the future communication is scheduled. For example, if the UE 115 and the base station 105 support self-scheduling on the cell 205, the base station 105 may transmit scheduling information for communication on the cell 205 to the UE 115 over an SS set on the same cell 205. Similarly, if the UE 115 and the base station 105 support self-scheduling on the cell 210, the base station 105 may transmit scheduling information for communication on the cell 210 to the UE 115 over an SS set on the same cell 210.

In some implementations, and as shown in FIG. 2, the UE 115 and the base station 105 may support a mix of (e.g., both) cross-carrier scheduling and self-scheduling. In some examples, for instance, the UE 115 and the base station 105 may support cross-carrier scheduling from the cell 210 (e.g., an SCell, such that the cell 210 may be referred to herein as a scheduling SCell) to the cell 205 (e.g., a P(S)Cell). In such examples, the UE 115 may monitor a physical downlink control channel (PDCCH) on the cell 210 to find control messages 215 (e.g., DCI messages or formats) that schedule data 220 on the cell 205 and the UE 115 also may monitor a PDCCH on the cell 205 to find control messages 215 (e.g., DCI messages or formats) that schedule data 220 on the cell 205. In some aspects, whether the UE 115 monitors the PDCCH on the cell 210 and the PDCCH on the cell 205 simultaneously may be based on a capability of the UE 115.

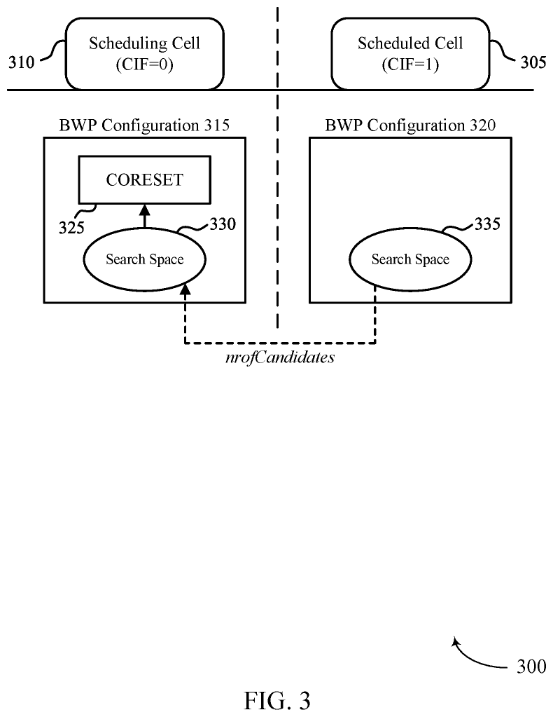

To support cross-carrier scheduling from the cell 210 (e.g., an SCell) to the cell 205 (e.g., a P(S)Cell), the UE 115 may determine a quantity of PDCCH candidates to monitor over an SS set of the cell 210 based on a configuration of one or more SS sets of the cell 205 and a linking between the SS set of the cell 210 and one of the SS sets of the cell 205. For example, for cross-carrier scheduling from an SCell to a P(S)Cell, the UE 115 may monitor a number of PDCCH monitoring candidates on the SCell (for scheduling the P(S)Cell) based on an SS set linking approach or procedure. In other words, at least the number of PDCCH monitoring candidates that the UE 115 monitors on the cell 210 (e.g., an SCell) for scheduling the cell 205 (e.g., a P(S)Cell) may be indicated to the UE 115 using the SS set linking approach or procedure. Additional details relating to such an SS set linking approach or procedure are illustrated by and described in more detail herein, including with reference to FIGS. 3 through 5.

As such, the UE 115 may monitor the cell 205 over a first SS set for first control messages 215 and may monitor the cell 210 over the determined number of PDCCH candidates in a linked SS set of the cell 210 for second control messages 215. The first control messages 215 and the second control messages 215 may schedule data 220 for communication between the UE 115 and the base station 105. The data 220 may include uplink data or downlink data, or both. As such, in some examples, the UE 115 may transmit the data 220 (or at least a portion of the data 220) to the base station 105 on the cell 205 over an uplink channel, such as a physical uplink shared channel (PUSCH). Additionally or alternatively, the UE 115 may receive the data 220 (or at least a portion of the data 220) from the base station 105 on the cell 205 over a downlink channel, such as a physical downlink shared channel (PDSCH).

Further, in some implementations, for cases in which the cell 210 (e.g., an SCell) is configured to scheduling a PDSCH or a PUSCH, or both, on the cell 205 (e.g., a PCell), the base station 105 and the UE 115 may achieve some flexibility for the SCell to schedule grants in accordance with one or more rules, constraints, or possibilities. For example, the UE 115 and the base station 105 may exclusively use the cell 210 for scheduling uplink grants for the cell 205, may use the cell 210 for scheduling both uplink grants and downlink grants (e.g., assignments) for the cell 205, or may exclusively use the cell 210 for scheduling downlink grants (e.g., assignments) for the cell 205. In some PDCCH SS set configurations, such as if a UE-specific SS (USS) is configured, the uplink and downlink DCI formats for that SS may be constrained to be configured together. For example, an information element dci-Formats can be configured as formats0-1-And-1-1 or as formats0-0-And-1-0. Due to such a constraint, and in scenarios in which DCI sizes of uplink grants and downlink grants are different (as may usually be the case for DCI format 0-1 and DCI format 1-1), the UE 115 may perform two blind detection attempts or two blind decoding attempts for each configured PDCCH monitoring candidate (e.g., one attempt for each DCI format).

As such, to support possibilities or options for exclusively using a specific cell for one of uplink grants or downlink grants without an unnecessary increase of PDCCH blind decoding or detection overhead on that specific cell (e.g., the cell 210), the UE 115 and the base station 105 may support an option for configuring DCI formats individually or separately for PUSCH scheduling, for PDSCH scheduling, or for both PUSCH and PDSCH scheduling. In some aspects, the UE 115 and the base station 105 may support such individual or separate options for configuring DCI formats as part of an SS set configuration used for that specific cell (e.g., the cell 210). In some implementations, for instance, the UE 115 and the base station 105 may support such individual or separate options for configuring DCI formats as part of an SS set configuration used for SCell to P(S)Cell scheduling. In other words, for cross-carrier scheduling from an SCell to a P(S)Cell, the UE 115 and the base station 105 may support a configuration of individual DCI format(s) (e.g., exclusively DCI format 0-1 o exclusively DCI format 1-1) as part of a corresponding SS set configuration.

Accordingly, in some implementations, the UE 115 and the base station 105 may support at least “format0-1” and “format1-1” as entries of dci-Formats in a SearchSpace configuration. For example, for a given SS configuration, the UE 115 may receive a parameter indicating for which of uplink grants or downlink grants the UE 115 may or is expected to monitor. As such, within a SearchSpace RRC signaling structure, the UE 115 and the base station 105 may support a searchSpaceType field including a ue-specific information element and the ue-specific information element may include one of multiple enumerated dci-Formats as “formats0-0-And-1-0,” optionally “formats0-1-And-1-1,” “format0-1,” and “format1-1.” The UE 115 and the base station 105 may use the parameters “format0-1,” and “format1-1” to indicate or identify whether the UE 115 is configured to monitor for DCI formats 0-1 or for DCI formats 1-1, or both.

In some examples, such as in examples in which multiple SS sets are configured for the cell 205 (e.g., the P(S)Cell), a SearchSpace configuration for a downlink grant and a SearchSpace configuration for an uplink grant may be different IDs (e.g., because the UE 115 is expected to monitor both). For example, a SearchSpace configuration associated with a crossCarrierSchedulingConfig information element may configure a third SS set for the cell 205 with an ID of x, a monitoringPeriodicityAndOffset parameter, a duration parameter, a monitoringSymbolsWithinSlot parameter, a nrofCandidates parameter, and a dci-Formats=format0-1. The same or a different SearchSpace configuration associated with the crossCarrierSchedulingConfig information element may configure a first SS set for the cell 205 with an with an ID of y, a monitoringPeriodicityAndOffset parameter, a duration parameter, a monitoringSymbolsWithinSlot parameter, and a nrofCandidates parameter.

In some aspects, the first SS set for the cell 205 may be linked with a second SS set for the cell 210, and a SearchSpace configuration associated with a crossCarrierSchedulingConfig information element may configure the second SS set for the cell 210 with an ID of y, a monitoringPeriodicityAndOffset parameter, a duration parameter, a monitoringSymbolsWithinSlot parameter, a nrofCandidates parameter, and a dci-Formats=format1-1. In such aspects, the UE 115 may refrain from monitoring the first SS set for the cell 205 and instead use the first SS set for the cell 205 to inform the UE 115 on a number of PDCCH candidates the UE 115 is to monitor over the second SS set for the cell 210. Further, in such aspects and in accordance with the individual or separate configurations of dci-Formats, the UE 115 may monitor the cell 205 over the third SS set for DCI formats 0-1 (e.g., DCI formats associated with an uplink grant) and may monitor the cell 210 over the second SS set for DCI formats 1-1 (e.g., DCI formats associated with a downlink grant).

In some other examples, a SearchSpace configuration for a downlink grant and a SearchSpace configuration for an uplink grant may have a same ID and the UE 115 may be configured or receive an indication to monitor both linked SS sets. In such examples, for instance, a SearchSpace configuration associated with a crossCarrierSchedulingConfig information element may configure the first SS set for the cell 205 with an ID of x, a monitoringPeriodicityAndOffset parameter, a duration parameter, a monitoringSymbolsWithinSlot parameter, a nrofCandidates parameter, and a dci-Formats=format0-1 and a SearchSpace configuration associated with a crossCarrierSchedulingConfig information element may configure the second SS set for the cell 210 with an ID of x, a monitoringPeriodicityAndOffset parameter, a duration parameter, a monitoringSymbolsWithinSlot parameter, a nrofCandidates parameter, and a dci-Formats=format1-1. As such, the UE 115 may monitor the cell 205 over the first SS set for DCI formats 0-1 (e.g., DCI 0_1, such as DCI formats associated with an uplink grant) and may monitor the cell 210 over the second SS set for DCI formats 1-1 (e.g., DCI1_1, such as DCI formats associated with a downlink grant).

Further, in some examples, the UE 115 and the base station 105 may support SS configurations on the cell 210 (e.g., an SCell) and on the cell 205 (e.g., an P(S)Cell) having a same SS index value such that the SS configurations are paired, and each of the paired SS configurations may be for an uplink grant, a downlink grant, or both. For example, the UE 115 and the base station 105 may support another parameter (either in SearchSpace or in crossCarrierSchedulingConfig) that informs, indicates, or otherwise tells the UE 115 that {none, exclusively downlink grant, exclusively uplink grant, or both} are to be monitored on the associated cell. If the parameter indicates ‘none,’ the SearchSpace configuration may be exclusively for linkage.

In such examples, a SearchSpace configuration associated with a crossCarrierSchedulingConfig information element may configure the first SS set for the cell 205 with an ID of y, a monitoringPeriodicityAndOffset parameter, a duration parameter, a monitoringSymbolsWithinSlot parameter, a nrofCandidates parameter, and a dci-Formats=format0-1-And-1-1 and a SearchSpace configuration associated with a crossCarrierSchedulingConfig information element may configure the second SS set for the cell 210 with an ID of y, a monitoringPeriodicityAndOffset parameter, a duration parameter, a monitoringSymbolsWithinSlot parameter, a nrofCandidates parameter, and a dci-Formats=format0-1-And-1-1. As such, the UE 115 may receive an additional parameter indicating one of “none,” “only downlink grant,” “only uplink grant,” or “both” for each SearchSpace configuration or for each crossCarrierSchedulingConfig information element (e.g., for each of the cell 205 and the cell 210) and the UE 115 may monitor the SS sets associated with that SearchSpace configuration or that crossCarrierSchedulingConfig information element (e.g., the cell associated with the crossCarrierSchedulingConfig information element) accordingly. In some aspects, the UE 115 may receive, from the base station 105, a first parameter indicating one of “none,” “only downlink grant,” “only uplink grant,” or “both” for the cell 205 and a second parameter indicating one of “none,” “only downlink grant,” “only uplink grant,” or “both” for the cell 210.

For example, the UE 115 may refrain from monitoring the linked SearchSpace configuration (e.g., the first SS set on the cell 205) and may instead use the linked SearchSpace configuration for providing parameters to the linked SearchSpace configuration in the scheduling cell if the first parameter indicates “none.” The UE 115 may monitor for DCI formats 1-1 on the linked SearchSpace configuration on the cell 205 if the first parameter indicates “only downlink grant.” The UE 115 may monitor for DCI formats 0-1 on the linked SearchSpace configuration on the cell 205 if the first parameter indicates “only uplink grant.” The UE 115 may monitor for both DCI formats 1-1 and 0-1 on the linked SearchSpace configuration on the cell 205 if the first parameter indicates “both.”

The UE 115 may not expect to receive a second parameter indicating “none” for the scheduling cell (e.g., the cell 210). The UE 115 may monitor for DCI formats 1-1 on the linked SearchSpace configuration on the cell 210 if the second parameter indicates “only downlink grant.” The UE 115 may monitor for DCI formats 0-1 on the linked SearchSpace configuration on the cell 210 if the second parameter indicates “only uplink grant.” The UE 115 may monitor for both DCI formats 1-1 and 0-1 on the linked SearchSpace configuration on the cell 210 if the second parameter indicates “both.”

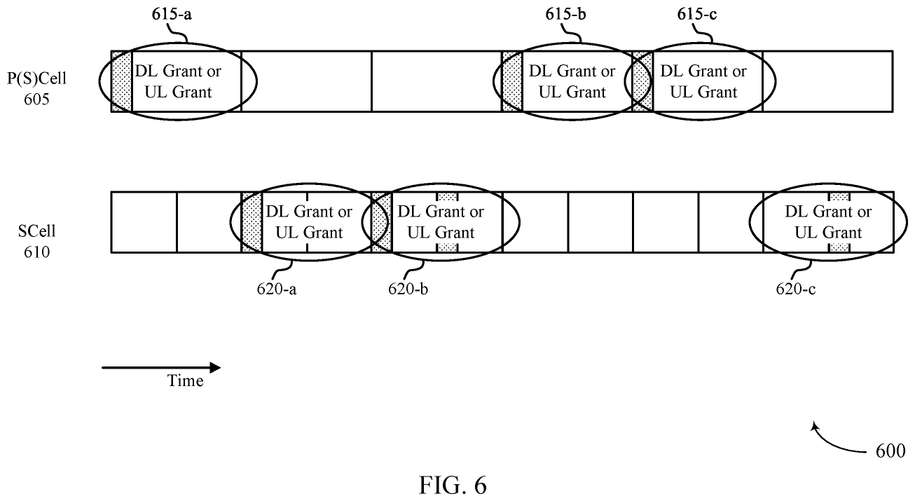

In some implementations, and based on supporting individual or separate configurations for whether to monitor for uplink grants or downlink grants, the UE 115 and the base station 105 may support a scheduling of monitoring over the cell 205 and the cell 210 in accordance with whether the cell 205 is configured for uplink grants or downlink grants, or both, and in accordance with whether the cell 210 is configured for uplink grants or downlink grants, or both. Additional details relating to such scheduling are illustrated by and described in more detail with reference to FIGS. 6 through 8.

FIG. 3 illustrates an example of a cross-carrier scheduling diagram 300 that supports techniques for cross-carrier scheduling from an SCell to a PCell in accordance with aspects of the present disclosure. The cross-carrier scheduling diagram 300 may implement or be implemented to realize aspects of the wireless communications system 100 or the wireless communications system 200. For example, the cross-carrier scheduling diagram 300 illustrates resource configurations for cross-carrier scheduling between a UE 115 and a base station 105 on a scheduled cell 305 and a scheduling cell 310. In other words, the UE 115 and the base station 105 may communicate control messages on the scheduling cell 310 and may communicate data messages scheduled by the control messages on the scheduled cell 305 (e.g., such that the scheduling cell 310 schedules the scheduled cell 305).

In some aspects, the scheduling cell 310 may be associated with a carrier indicator field (CIF) value of 0 (e.g., CIF=0) and the scheduled cell 305 may be associated with a CIF value different than 0 (such that the scheduling cell 310 and the scheduled cell 305 are associated with different component carriers). For example, the scheduled cell 305 may be associated with a CIF value of 1 (e.g., CIF=1). Further, in some aspects, the UE 115 and the base station 105 may support different subcarrier spacings (SCSs) between the scheduling cell 310 and the scheduled cell 305. The scheduling cell 310 and the scheduled cell 305 may be associated with different BWP configurations. For example, the scheduling cell 310 may be associated with a BWP configuration 315 and the scheduled cell 305 may be associated with a BWP configuration 320. The BWP configuration 315 may be associated with or indicate a CORESET 325 including or otherwise associated with an SS 330 and the BWP configuration 320 may be associated with or indicate an SS 335.

In some implementations, the UE 115 may use an SS with a first ID configured on a BWP of the scheduled cell 305 to determine a number of PDCCH candidate(s) for each aggregation level monitored in an SS with the same first ID configured on a BWP of the scheduling cell 310 for the BWP of the scheduled cell 305. In other words, if an SS on the scheduling cell 310 has a same configured SS ID as an SS on the scheduled cell 305, the UE 115 may determine a number of PDCCH monitoring candidates for the SS on the scheduling cell 310 based on a configured number of PDCCH candidates for the SS on the scheduled cell 305. For example, if the SS 330 on the scheduling cell 310 is associated with a first SS ID (e.g., an SS ID #) and the SS 335 on the scheduled cell 305 is associated with the same first SS ID (e.g., the SS ID #), the UE 115 may monitor a number of PDCCH candidates of the SS 330 for scheduling the scheduled cell 305 equal to a number of PDCCH candidates configured for the SS 335. In some aspects, the UE 115 may receive a control message, such as an RRC control message, including an nrofCandidates parameter for the SS 335 and may apply the nrofCandidates parameter to the SS 330 (for each aggregation level) based on determining that the SS 330 and the SS 335 have matching SS IDs.

In some examples, the nrofCandidates parameter may indicate two separate values, including a first value for the scheduling cell 310 (e.g., for CIF=0) and a second value for the scheduled cell 305 (e.g., for CIF=1). In an example, the first value for the scheduling cell 310 may be four and the second value for the scheduled cell 305 may be two. Further, the UE 115 may receive a searchSpaceSharing parameter as an optional capability. In some cases, the UE 115 may feature or be associated with a monitoring capability. For example, the UE 115 may feature or be associated with a blind detection or CCE limit constraint per scheduled cell. In such examples, such a blind detection or CCE limit or constraint per scheduled cell may be defined as a minimum of a carrier aggregation limit or constraint and a per-component carrier limit or constraint (e.g., min{CA-limit, per-CC limit}).

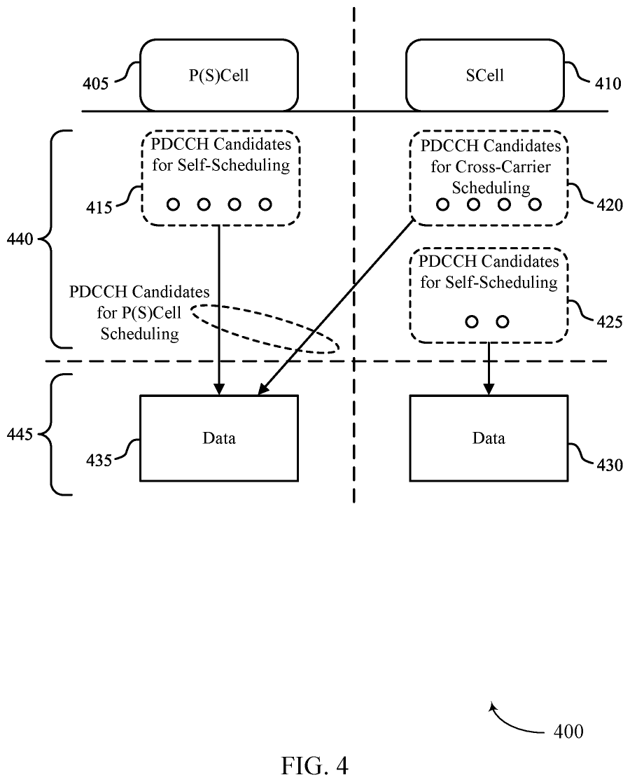

FIG. 4 illustrates an example of a cross-carrier scheduling diagram 400 that supports techniques for cross-carrier scheduling from an SCell to a PCell in accordance with aspects of the present disclosure. The cross-carrier scheduling diagram 400 may implement or be implemented to realize one or more aspects of the wireless communications system 100 or the wireless communications system 200. For example, the cross-carrier scheduling diagram 400 illustrates resource configurations for cross-carrier scheduling between a UE 115 and a base station 105 on a P(S)Cell 405 and an SCell 410. As described herein, the P(S)Cell 405 may refer to a PCell or a PSCell.

In some implementations, the UE 115 and the base station 105 may support both cross-carrier scheduling from the SCell 410 to the P(S)Cell 405 and self-scheduling by the P(S)Cell 405. For example, the UE 115 may monitor the P(S)Cell 405 over an SS set 415 including a number of PDCCH candidates for self-scheduling (e.g., such as four PDCCH candidates) and may monitor the SCell 410 over an SS set 420 including a number of PDCCH candidates for cross-carrier scheduling (e.g., such as four PDCCH candidates). In some aspects, the number of PDCCH candidates in the SS set 420 may be based on a number of PDCCH candidates configured via a nrofCandidates parameter associated with a linked SS set of the P(S)Cell 405. As such, a number of PDCCH candidates for scheduling the P(S)Cell 405 may include both the number of PDCCH candidates in the SS set 415 and the number of PDCCH candidates in the SS set 420. Further, in some examples, the UE 115 also may monitor the SCell 410 over an SS set 425 including a number of PDCCH candidates for self-scheduling. Altogether, the UE 115 may monitor a number of PDCCH candidates 440.

In some aspects, the base station 105 may transmit, and the UE 115 may receive, one or more first control messages over one or more PDCCH candidates in the SS set 415 scheduling data 435 (e.g., self-scheduling data 435) on the P(S)Cell 405 and the base station 105 may transmit one or more second control messages over one or more PDCCH candidates in the SS set 420 scheduling data 435 (e.g., scheduling in a cross-carrier manner) on the P(S)Cell 405. Further, the base station 105, and the UE 115 may receive, one or more third control messages over the one or more PDCCH candidates in the SS set 425 scheduling data 430 (e.g., self-scheduling data 430) on the SCell 410. The data 430 and the data 435 may include one or both of uplink data or downlink data and the UE 115 and the base station 105 may likewise communicate the data 430 and the data 435 over one or both of a PUSCH or a PDSCH. Altogether, the UE 115 may communicate data 445 (e.g., including the data 430 and the data 435) with the base station 105 on the P(S)Cell 405 and the SCell 410.

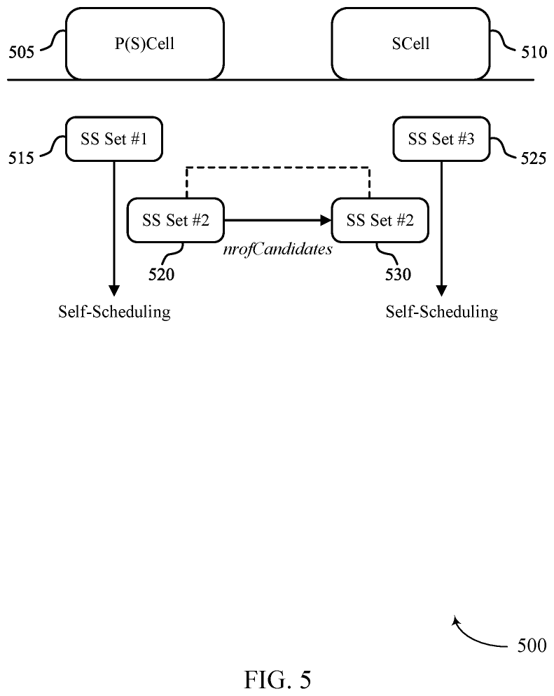

FIG. 5 illustrates an example of a cross-carrier scheduling diagram 500 that supports techniques for cross-carrier scheduling from an SCell to a PCell in accordance with aspects of the present disclosure. The cross-carrier scheduling diagram 500 may implement or be implemented to realize one or more aspects of the wireless communications system 100 or the wireless communications system 200. For example, the cross-carrier scheduling diagram 500 illustrates resource configurations for cross-carrier scheduling between a UE 115 and a base station 105 on a P(S)Cell 505 and an SCell 510. As described herein, the P(S)Cell 505 may refer to a PCell or a PSCell.

In some implementations, the UE 115 may receive, from the base station 105, at least one control message that configures, indicates, or otherwise identifies an SS set 515 and an SS set 520 for the P(S)Cell 505 and that configures, indicates, or otherwise identifies an SS set 525 and an SS set 530 for the SCell 510. In some examples, the at least one control message also may inform the UE 115 that the UE 115 is configured with cross-carrier scheduling from an SCell to the P(S)Cell 505 and which SCell is the scheduling SCell (e.g., the at least one control message may identify the SCell 510 as the scheduling SCell for the P(S)Cell 505). In some cases, a scheduling SCell may be equivalently referred to as a scheduling SCell (sSCell). In some aspects, the UE 115 may receive the at least one control message from the base station 105 via RRC signaling, such as via an RRC configuration. For example, the UE 115 may receive an RRC message including a crossCarrierSchedulingConfig parameter that is configured to the P(S)Cell 505 and informs the UE 115 of such information or may receive another one or more SS configuration parameters.

As such, the UE 115 may check to see if there is an SS set (or if there are multiple SS sets) having a same ID in the P(S)Cell 505 and the SCell 510 (e.g., to determine which SS set on the SCell 510 over which the UE 115 may expect cross-carrier scheduling and to determine how many PDCCH candidates to monitor over that SS set). For example, if there is an SS set, such as the SS set 515 having an ID #1, configured on the P(S)Cell 505 whose ID is not matched with any SS set(s) configured on the SCell 510, the UE 115 may determine that the SS set is for self-scheduling on the P(S)Cell 505. As shown in the cross-carrier scheduling diagram 500, the SS set 515 having an ID #1 may be for self-scheduling on the P(S)Cell 505. Similarly, if there is an SS set, such as the SS set 525 having an ID #3, configured on the SCell 510 whose ID is not matched with any SS set(s) configured on the P(S)Cell 505, the UE 115 may determine that the SS set is for self-scheduling on the SCell 510. As shown in the cross-carrier scheduling diagram 500, the SS set 525 having an ID #3 may be for self-scheduling on the SCell 510.

Further, if there is an SS set, such as the SS set 520 having an ID #2, configured on the P(S)Cell 505 whose ID is matched with an SS set(s) configured on the SCell 510, such as the SS set 530 also having the ID #2, the UE 115 may use the nrofCandidates parameter configured for the SS set on the P(S)Cell 505 with the matched ID (e.g., the SS set 520) to identify the number of PDCCH candidates in the SS set configured on the SCell 510 with the matched ID (e.g., the SS set 530). For example, the nrofCandidates parameter may be configured for the SS set 530 on the SCell 510 as part of an SS configuration for the SS set 530 on the SCell 510, and the UE 115 may use the nrofCandidates parameter to identify the number of PDCCH candidates in the SS set 530 configured on the SCell 510.

The UE 115 may configure or identify two values for the nrofCandidates parameter for the SS set 530 on the SCell 510 including a first nrofCandidates for an own SS configuration on the SCell 510 and a second nrofCandidates for an SS configuration for SS set 520 on the P(S)Cell 505. The first nrofCandidates may indicate a number of PDCCH candidates for self-scheduling on the SCell 510 and the second nrofCandidates may indicate a number of PDCCH candidates for cross-carrier scheduling to the P(S)Cell 505.

In some examples, and if there is an SS set configured on the P(S)Cell 505, such as the SS set 520, which has a matching ID with an SS set configured on the SCell 510, such as the SS set 530, the UE 115 and the base station 105 may support selective or conditional communication over the SS set on the P(S)Cell 505 (e.g., the SS set 520) which is linked with the SS set on the SCell 510 (e.g., the SS set 530) via matching IDs. In some implementations, for example, UE 115 may suppress or otherwise refrain from monitoring PDCCH candidates in the SS set 520 on the P(S)Cell 505 which is linked to the SS set 530 with the same ID on the SCell 510 based on the linking. In other words, as a result of the SS set 520 being linked with the SS set 530 by virtue of matching IDs, the UE 115 may suppress or otherwise refrain from monitoring over the SS set 520. In such implementations, and as long as the SS set ID linkage is established, the UE 115 may consider that the SS set 520 configured on the P(S)Cell 505 which is linked to the

SS set 530 on the SCell 510 by the same ID is for the purpose of providing nrofCandidates to the SS set 530 on SCell 510 (e.g., and not for the purpose of actually scheduling communication).

In some other implementations, the UE 115 may determine whether or not to monitor one or more PDCCH candidates in the SS set 520 on the P(S)Cell 505 which is linked to the SS set 530 with the same ID on the SCell 510 based on one or more conditions. In some aspects, the one or more conditions may be associated with the SS set 520. For example, the one or more conditions may be associated with a presence or configuration (or lack thereof) of one or more parameters associated with an SS configuration for the SS set 520.

In some examples, for instance, if a CORESET index (e.g., a controlResourceSetId) associated with the SS set 520 is not included in the SS configuration of the SS set 520 on the P(S)Cell 505 which is linked to the SS set 530 on the SCell 510 by ID, the UE 115 may suppress or otherwise refrain from monitoring PDCCH candidates in the SS set 520 on the P(S)Cell 505 (e.g., regardless of what values are configured as nrofCandidates in the SS set 520 on the P(S)Cell 505). For example, the UE 115 may be unable to monitor a PDCCH if an SS configuration and its associated CORESET configuration are not identified or configured, but controlResourceSetId in a searchSpace information element is optional (e.g., it is possible that the base station 105 may refrain from configuring it). Accordingly, the UE 115 may monitor the P(S)Cell 505 over the SS set 520 if a control message includes controlResourceSetId and may suppress or refrain from monitoring the P(S)Cell 505 over the SS set 520 if the control message does not include controlResourceSetId. Likewise, the base station 105 may transmit on the P(S)Cell 505 over the SS set 520 if the control message includes controlResourceSetId and may suppress or refrain from transmitting on the P(S)Cell 505 over the SS set 520 if the control message does not include controlResourceSetId.

Additionally or alternatively, if searchSpace Type (which may indicate whether an SS set is a common search space (CSS) set or a UE-specific search space (USS) set) is not included in the SS configuration of the SS set 520 on the P(S)Cell 505 which is linked to the SS set 530 on the SCell 510 by ID, the UE 115 may suppress or otherwise refrain from monitoring PDCCH candidates in the SS set 520 on the P(S)Cell 505 (e.g., regardless of what values are configured as nrofCandidates in the SS set 520 on the P(S)Cell 505). Accordingly, the UE 115 may monitor the P(S)Cell 505 over the SS set 520 if a control message includes searchSpaceType and may suppress or refrain from monitoring the P(S)Cell 505 over the SS set 520 if the control message does not include searchSpaceType. Likewise, the base station 105 may transmit on the P(S)Cell 505 over the SS set 520 if the control message includes searchSpaceType and may suppress or refrain from transmitting on the P(S)Cell 505 over the SS set 520 if the control message does not include searchSpaceType.

Additionally or alternatively, if monitoringSymbolsWithinSlot (which may indicate a bit-map to inform the UE 115 on which OFDM symbol(s) of a slot the UE 115 may monitor a PDCCH) is not included in the SS configuration of the SS set 520 on the P(S)Cell 505 which is linked to the SS set 530 on the SCell 510 by ID, the UE 115 may suppress or otherwise refrain from monitoring PDCCH candidates in the SS set 520 on the P(S)Cell 505 (e.g., regardless of what values are configured as nrofCandidates in the SS set 520 on the P(S)Cell 505). Accordingly, the UE 115 may monitor the P(S)Cell 505 over the SS set 520 if a control message includes monitoringSymbolsWithinSlot and may suppress or refrain from monitoring the P(S)Cell 505 over the SS set 520 if the control message does not include monitoringSymbolsWithinSlot. Likewise, the base station 105 may transmit on the P(S)Cell 505 over the SS set 520 if the control message includes monitoringSymbolsWithinSlot and may suppress or refrain from transmitting on the P(S)Cell 505 over the SS set 520 if the control message does not include monitoringSymbolsWithinSlot.

Additionally or alternatively, the UE 115 may determine whether to monitor the P(S)Cell 505 over the SS set 520 or to suppress monitoring the P(S)Cell 505 over the SS set 520 based on a parameter that is exclusively configured for indicating whether the UE 115 is to monitor the SS set 520 on the P(S)Cell 505 which is linked to the SS set 520 on the SCell 510 by ID. For example, the UE 115 and the base station 105 may support or introduce a new parameter under the searchSpace information element and the parameter may indicate whether the UE 115 is to (e.g., is expected to) monitor PDCCH candidates in the SS set 520 on the P(S)Cell 505. As such, the UE 115 may monitor the P(S)Cell 505 over the SS set 520 if a control message indicates a first value for the parameter and may suppress or refrain from monitoring the P(S)Cell 505 over the SS set 520 if the control message indicates a second value for the parameter. Likewise, the base station 105 may transmit on the P(S)Cell 505 over the SS set 520 if the control message indicates the first value for the parameter and may suppress or refrain from transmitting on the P(S)Cell 505 over the SS set 520 if the control message indicates the second value for the parameter.

As such, the UE 115 may determine whether or not the UE 115 is expected to monitor PDCCH candidates on the SS set 520 in the P(S)Cell 505 which is linked to the SS set 530 in the SCell 510 based on their matching IDs. Further, the base station 105 may indicate, to the UE 115, whether the UE 115 is expected to monitor PDCCH candidates on the SS set 530 in the SCell 510 which is linked to the SS set 520 in the P(S)Cell 505 based on their matching IDs by configuring a specific value of nrofCandidates in the SS configuration for the SS set 530 on the SCell 510. For example, the base station 105 may indicate whether the UE 115 is expected to monitor the SCell 510 over the SS set 530 based on indicating all zero values for the nrofCandidates or based on indicating non-zero values for the nrofCandidates.

As a result, if SS set linkage is established between the P(S)Cell 505 and the SCell 510, the UE 115 may be expected to monitor PDCCH on both cells or to monitor PDCCH on the SCell 510 (e.g., but not monitor PDCCH on the P(S)Cell 505). Further, because the linkage between the P(S)Cell 505 and the SCell 510 is configured for cross-carrier scheduling from the SCell 510 to the P(S)Cell 505, it may be unsuitable for the UE 115 to monitor PDCCH only on the P(S)Cell 505.

FIG. 6 illustrates an example of a communication timeline 600 that supports techniques for cross-carrier scheduling from an SCell to a PCell in accordance with aspects of the present disclosure. The communication timeline 600 may implement or be implemented to realize one or more aspects of the wireless communications system 100 or the wireless communications system 200. For example, the communication timeline 600 illustrates resource configurations for cross-carrier scheduling between a UE 115 and a base station 105 on a P(S)Cell 605 and an SCell 610. As described herein, the P(S)Cell 605 may refer to a PCell or a PSCell.

In some cases, a UE 115 may be an example of or otherwise function as one of two different types of UE. For example, the UE 115 may be a Type A UE or a Type B UE, both of which may support cross-carrier scheduling from the SCell 610 to the P(S)Cell 605. For a Type A UE, some SS sets on the P(S)Cell 605 and the SCell 610 may be configured such that the UE 115 may refrain from monitoring (e.g., is not expected to monitor) the SS sets in overlapping slots or symbols of the P(S)Cell 605 and the SCell 610. For example, on the P(S)Cell 605, the UE 115 may refrain from monitoring for USS sets for DCI formats 0_1, 1_1, 0_2, 1_2 (if supported for a Type A UE), USS sets for DCI formats 0_0, 1_0, or Type3-cell-specific SS (CSS) set(s) for DCI formats 1_0, 0_0 with an RNTI value associated with coding/decoding if the UE 115 is configured for simultaneous SS set monitoring on the SCell 610. Such an RNTI value may be a C-RNTI, a CS-RNTI, an MCS-C-RNTI, or any combination thereof. On the SCell 610, the UE 115 may refrain from monitoring for USS set(s) for scheduling communication on the P(S)Cell 605 if the UE 115 is configured for simultaneous SS set monitoring on the P(S)Cell 605. In other words, a Type A UE may not be required to be able to monitor SS sets for unicast PDCCH on the SCell 610 and the P(S)Cell 605 at a given slot or symbol. Some considerations may also be made relating to blind detection or CCE constraints. In other words, the UE 115 may monitor PDCCH for scheduling unicast PDSCH/PUSCH per a specific time period or duration on one of (and not both) the P(S)Cell 605 or the SCell 610.

For a Type B UE, some SS sets on the P(S)Cell 605 and the SCell 610 may be configured such that the UE 115 monitors the SS sets in overlapping slots or symbols of the P(S)Cell 605 and the SCell 610. For example, on the P(S)Cell 605, the UE 115 may monitor for USS sets for DCI formats 0_0, 1_0 and Type3-CSS set(s) for DCI formats 1_0, 0_0 with an RNTI value associated with coding/decoding if the UE 115 is configured for simultaneous SS set monitoring on the SCell 610. Such an RNTI value may be a C-RNTI, a CS-RNTI, an MCS-C-RNTI, or any combination thereof. On the SCell 610, the UE 115 may monitor for USS set(s) for scheduling communication on the P(S)Cell 605 if the UE 115 is configured for simultaneous SS set monitoring on the P(S)Cell 605. In other words, a Type B UE may be able to monitor SS sets for unicast PDCCH on the SCell 610 and the P(S)Cell 605 at a given slot or symbol. In other words, the UE 115 may monitor PDCCH for scheduling unicast PDSCH/PUSCH on the P(S)Cell 605 per a specific time period or duration on both of the P(S)Cell 605 and the SCell 610.

In some aspects, for handling or configuring USS sets for scheduling P(S)Cell 605 on the P(S)Cell 605 or on the SCell 610, or both, for DCI formats 0_1, 1_1, 0_2, 1_2, the UE 115 may select to monitor one of the P(S)Cell 605 or the SCell 610 at a given time. In some aspects, there may be no restriction on Type-0/0A/1/2-CSS sets configurations and some considerations may be made relating to blind detection or CCE constraints.

In some implementations, and in scenarios in which the UE 115 is a Type A UE 115, the UE 115 and the base station 105 may support a monitoring configuration for the UE 115 such that monitoring occasions for exclusively downlink grants (e.g., DCI formats 1_1 and 1_2) and monitoring occasions for exclusively uplink grants (e.g., DCI formats 0_1 and 0_2) on two cells do not overlap in time. For example, even if the UE 115 is configured for different grant types on the P(S)Cell 605 and the SCell 610, the UE 115 and the base station 105 may support (e.g., and optionally signal) a configuration such that monitoring occasions for the different grant types avoid overlapping in time (e.g., over one or more slots or symbols). Similarly, the configuration may also be such that same grant types on the P(S)Cell 605 and the SCell 610 avoid overlapping in time (e.g., over one or more slots or symbols).

In other words, the base station 105 may configure monitoring occasions for downlink grant and downlink grant on two cells or monitoring occasions for uplink grant and uplink grant on two cells such that the monitoring occasions avoid overlapping in time. For example, in accordance with the described configuration and as shown in FIG. 6, a monitoring occasion 615-a, a monitoring occasion 615-b, and a monitoring occasion 615-c for one or both of downlink grants or uplink grants on the P(S)Cell 605 may avoid overlapping in time (e.g., at the slot level or at the symbol level) with a monitoring occasion 620-a, a monitoring occasion 620-b, and a monitoring occasion 620-c for one or both of downlink grants or uplink grants on the SCell 610.

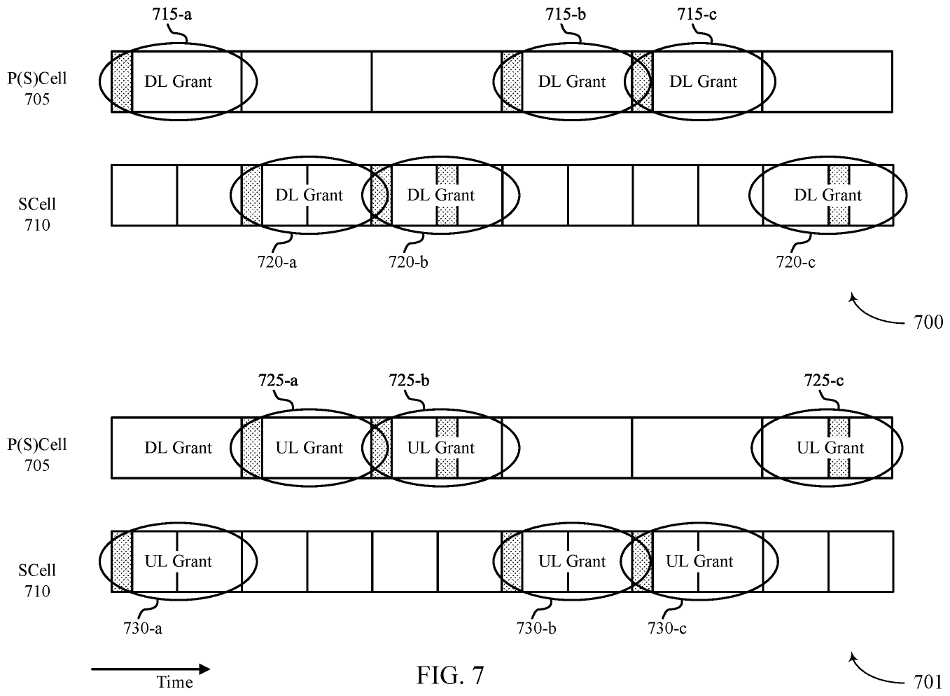

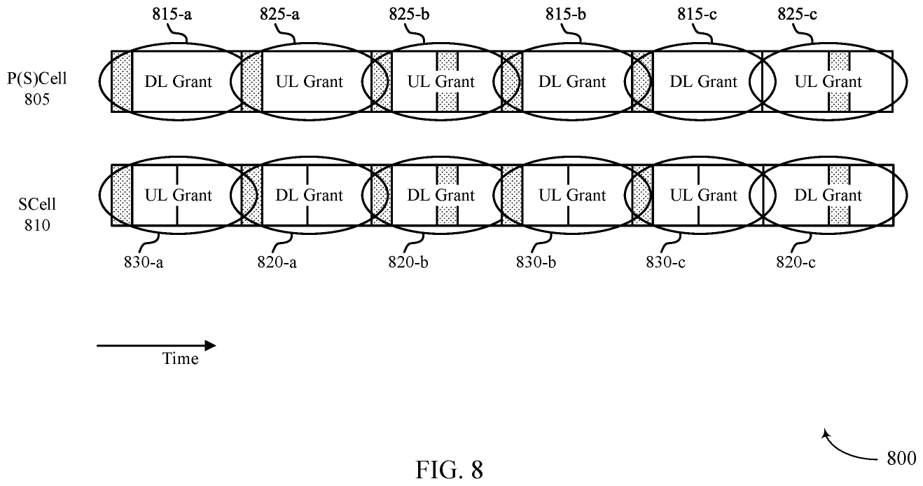

FIG. 7 illustrates an example of a communication timelines 700 and 701 that supports techniques for cross-carrier scheduling from an SCell to a PCell in accordance with aspects of the present disclosure. The communication timelines 700 and 701 may implement or be implemented to realize one or more aspects of the wireless communications system 100 or the wireless communications system 200. For example, the communication timelines 700 and 701 illustrate resource configurations for cross-carrier scheduling between a UE 115 and a base station 105 on a P(S)Cell 705 and an SCell 710. As described herein, the P(S)Cell 705 may refer to a PCell or a PSCell. In some aspects, the communication timelines 700 and 701 may illustrate different constraints associated with overlapping uplink grants and downlink grants over a same time period and a communication timeline 800, as shown in FIG. 8, illustrates an overlapping or combination of the communication timelines 700 and 701.

In some aspects, for a Type A UE, some SS sets on the P(S)Cell 705 and some SS sets on the SCell 710 are configured (by the base station 105) such that the UE 115 may refrain from monitoring for such SS sets in overlapping slots or symbols of the P(S)Cell 705 and the SCell 710. For example, for SS sets on the P(S)Cell 705, the UE 115 may refrain from monitoring USS sets at least for DCI formats 1_1, 1_2 (if supported for a Type A UE), USS sets at least for DCI formats 1_0, or Type3-CSS set(s) for DCI formats 1_0/0_0 with C-RNTI, CS-RNTI, or MCS-C-RNTI if the UE 115 is configured to simultaneously monitor SS sets on the SCell 710. For SS sets on the SCell 710, the UE 115 may refrain from monitoring for USS set(s) at least for DCI formats 1_1/1_2 for scheduling communication on the P(S)Cell 705 if the UE 115 is configured to simultaneously monitor SS sets on the P(S)Cell 705. In other words, the UE 115 may refrain from monitoring for downlink grants for unicast PDSCH simultaneously on the P(S)Cell 705 and the SCell 710.

For example, in accordance with the described configuration and as shown in the communication timeline 700, a monitoring occasion 715-a, a monitoring occasion 715-b, and a monitoring occasion 715-c for (exclusively) downlink grants on the P(S)Cell 705 may avoid overlapping in time (e.g., at the slot level or at the symbol level) with a monitoring occasion 720-a, a monitoring occasion 720-b, and a monitoring occasion 720-c for (exclusively) downlink grants on the SCell 710.

Additionally or alternatively, some other SS sets on the P(S)Cell 705 and some SS sets on the SCell 710 are configured (by the base station 105) such that the UE 115 may refrain from monitoring for such other SS sets in overlapping slots or symbols of the P(S)Cell 705 and the SCell 710. For example, for SS sets on the P(S)Cell 705, the UE 115 may refrain from monitoring USS sets at least for DCI formats 0_1, 0_2 (if supported for a Type A UE), USS sets at least for DCI formats 0_0, or Type3-CSS set(s) for DCI formats 1_0/0_0 with C-RNTI, CS-RNTI, or MCS-C-RNTI if the UE 115 is configured to simultaneously monitor SS sets on the SCell 710. For SS sets on the SCell 710, the UE 115 may refrain from monitoring for USS set(s) at least for DCI formats 0_1/0_2 scheduling communication on the P(S)Cell 705 if the UE 115 is configured to simultaneously monitor SS sets on the P(S)Cell 705. In other words, the UE 115 may refrain from monitoring for uplink grants for unicast PUSCH simultaneously on the P(S)Cell 705 and the SCell 710.

For example, in accordance with the described configuration and as shown in the communication timeline 701, a monitoring occasion 725-a, a monitoring occasion 725-b, and a monitoring occasion 725-c for (exclusively) uplink grants on the P(S)Cell 705 may avoid overlapping in time (e.g., at the slot level or at the symbol level) with a monitoring occasion 730-a, a monitoring occasion 730-b, and a monitoring occasion 730-c for (exclusively) uplink grants on the SCell 710.

In some implementations, the UE 115 (a Type A UE) and the base station 105 may support an absence of a restriction (e.g., an allowance) for overlapping monitoring occasions between downlink grant(s) and uplink grant(s). For example, the UE 115 may monitor for both downlink grants and uplink grants simultaneously if the downlink grants are configured for a different serving cell than the uplink grants. Additional details relating to such an allowance for overlapping monitoring occasions between downlink grant(s) and uplink grant(s) are illustrated by and described with reference to FIG. 8.

FIG. 8 illustrates an example of a communication timeline 800 that supports techniques for cross-carrier scheduling from an SCell to a PCell in accordance with aspects of the present disclosure. The communication timeline 800 may implement or be implemented to realize one or more aspects of the wireless communications system 100 or the wireless communications system 200. For example, the communication timeline 800 illustrates resource configurations for cross-carrier scheduling between a UE 115 and a base station 105 on a P(S)Cell 805 and an SCell 810. As described herein, the P(S)Cell 805 may refer to a PCell or a PSCell. In some aspects, the communication timeline 800 illustrates different constraints associated with overlapping uplink grants and downlink grants over a same time period and an allowance for overlapping monitoring occasions between downlink grants and uplink grants.

For example, and as shown in the communication timeline 800, a monitoring occasion 815-a, a monitoring occasion 815-b, and a monitoring occasion 815-c for (exclusively) downlink grants on the P(S)Cell 805 may avoid overlapping in time (e.g., at the slot level or at the symbol level) with a monitoring occasion 820-a, a monitoring occasion 820-b, and a monitoring occasion 820-c for (exclusively) downlink grants on the SCell 810. Similarly, a monitoring occasion 825-a, a monitoring occasion 825-b, and a monitoring occasion 825-c for (exclusively) uplink grants on the P(S)Cell 805 may avoid overlapping in time (e.g., at the slot level or at the symbol level) with a monitoring occasion 830-a, a monitoring occasion 830-b, and a monitoring occasion 830-c for (exclusively) uplink grants on the SCell 810.

In implementations in which the UE 115 is a Type A UE and based on supporting individual or separate parameters for indicating whether to monitor for uplink grants or downlink grants, the UE 115 and the base station 105 may further support a configuration for allowing overlapping SS sets across cells if the overlapping SS sets are configured for different ones of uplink grants and downlink grants. For example, and as shown in the communication timeline 800, the monitoring occasion 815-a for a downlink grant on the P(S)Cell 805 may overlap in time with the monitoring occasion 830-a for an uplink grant on the SCell 810, the monitoring occasion 825-a for an uplink grant on the P(S)Cell 805 may overlap in time with the monitoring occasion 820-a for a downlink grant on the SCell 810, and so on.

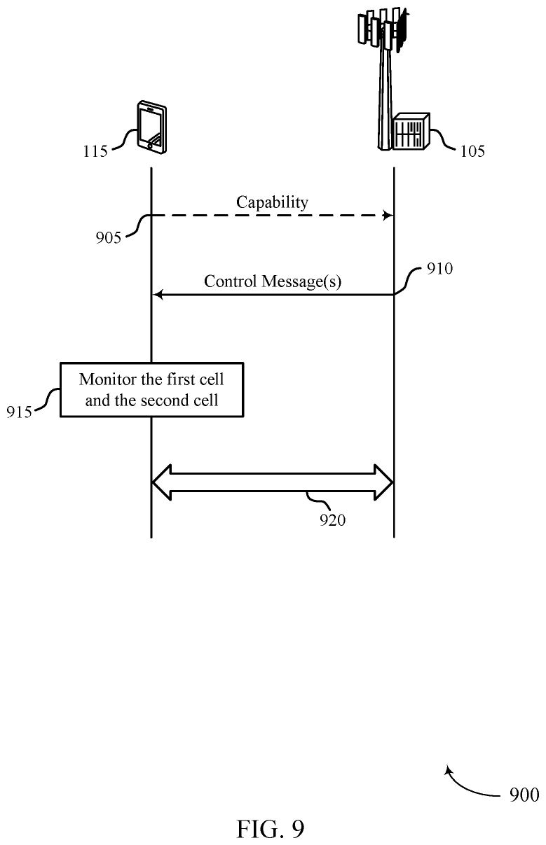

FIG. 9 illustrates an example of a process flow 900 that supports techniques for cross-carrier scheduling from an SCell to a PCell in accordance with aspects of the present disclosure. The process flow 900 may implement or be implemented to realize aspects of the wireless communications system 100, the wireless communications system 200, the cross-carrier scheduling diagram 300, the cross-carrier scheduling diagram 400, the cross-carrier scheduling diagram 500, the communication timeline 600, the communication timeline 700, or the communication timeline 800. For example, the process flow 900 illustrates communication between a UE 115 and a base station 105 and the UE 115 and the base station 105 may communicate with each other on various serving cells, including a P(S)Cell (which may be an example of a PCell or a PSCell) and an SCell.

In the following description of the process flow 900, the operations may be performed (such as reported or provided) in a different order than the order shown, or the operations performed by the example devices may be performed in different orders or at different times. Some operations also may be omitted from the process flow 900, or other operations may be added to the process flow 900. Further, although some operations or signaling may be shown to occur at different times for discussion purposes, these operations may actually occur at the same time or otherwise concurrently.

At 905, the UE 115 may, in some implementations, transmit, to the base station 105, an indication that a capability of the UE 115 is associated with monitoring of a first cell (e.g., a P(S)Cell) for both uplink grants and downlink grants and monitoring of a second cell (e.g., an SCell) for both uplink grants and downlink grants over non-overlapping monitoring occasions. In some aspects, such a capability may be associated with a Type A UE.

At 910, the UE 115 may receive, from the base station 105, one or more control messages identifying a first SS set for the first cell and a second SS set for the second cell. In some examples, the first SS set for the first cell may be linked, for cross-carrier scheduling of the first cell by the second cell, with the second SS set for the second cell. Further, in some examples, the one or more control messages may include a first parameter indicating whether the UE 115 is to monitor for uplink grants, downlink grants, or both for the first cell (e.g., over SS sets for the first cell) and a second parameter indicating whether the UE 115 is to monitor for uplink grants, downlink grants, or both for the second cell (e.g., over SS sets for the second cell).

In some aspects, the first parameter may indicate a first subset of DCI formats for monitoring for the first SS set and a second subset of DCI formats for monitoring for the second SS set (e.g., if the parameters are conveyed by SearchSpace configurations having same IDs). In some other aspects, the first parameter may indicate a first subset of DCI formats for monitoring for a third SS set of the first cell and a second subset of DCI formats for monitoring for the second SS set (e.g., if the parameters are conveyed by SearchSpace configurations having different IDs). Additionally or alternatively, the first parameter may indicate monitoring for one of the uplink grants or the downlink grants for the first cell and the second parameter may indicate monitoring for the other of the uplink grants or the downlink grants for the second cell. The linking between the first SS set and the second SS set may inform the UE 115 of a number of PDCCH candidates for monitoring for the second cell over the second SS set.

At 915, the UE 115 may monitor, based on the first parameter and the second parameter, the first cell over one of the first SS set or the third SS set for one of the uplink grants or the downlink grants and may monitor the second cell over the second SS set for the other one of the uplink grants or the downlink grants. For example, the UE 115 may monitor for uplink grants on one cell and may monitor for downlink grants on the other cell. In some aspects, the monitoring may include monitoring for specific DCI formats indicated by the first parameter and the second parameter.

At 920, the UE 115 and the base station 105 may communicate on at least the first cell (e.g., the P(S)Cell) based on the uplink grants or the downlink grants. In some examples, for instance, the UE 115 may transmit an uplink data message over a PUSCH to the base station 105 on the first cell based on first scheduling information in the uplink grants and may receive a downlink data message over a PDSCH from the base station 105 on the first cell based on second scheduling information in the downlink grants.

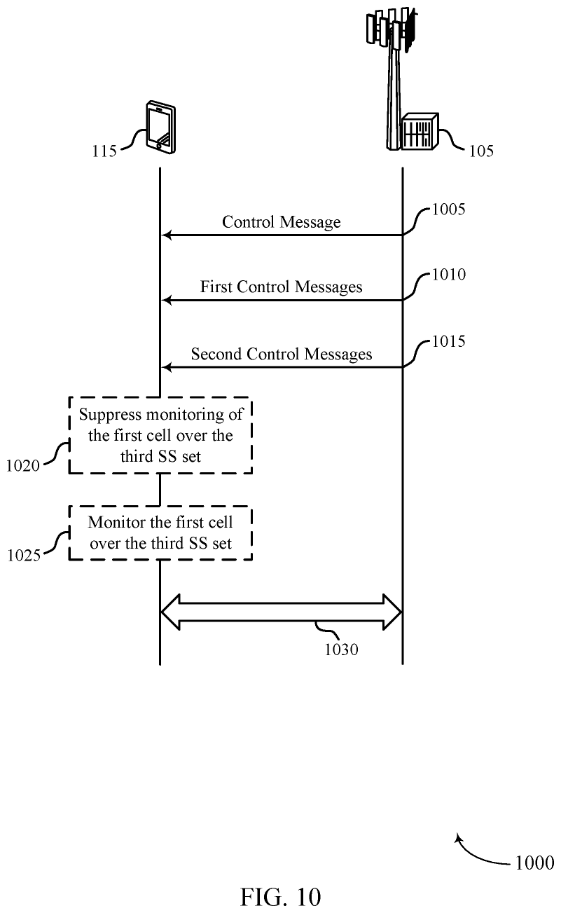

FIG. 10 illustrates an example of a process flow 1000 that supports techniques for cross-carrier scheduling from an SCell to a PCell in accordance with examples as disclosed herein. The process flow 1000 may implement or be implemented to realize aspects of the wireless communications system 100, the wireless communications system 200, the cross-carrier scheduling diagram 300, the cross-carrier scheduling diagram 400, or the cross-carrier scheduling diagram 500. For example, the process flow 1000 illustrates communication between a UE 115 and a base station 105 and the UE 115 and the base station 105 may communicate with each other on various serving cells, including a P(S)Cell (which may be an example of a PCell or a PSCell) and an SCell.

In the following description of the process flow 1000, the operations may be performed (such as reported or provided) in a different order than the order shown, or the operations performed by the example devices may be performed in different orders or at different times. Some operations also may be omitted from the process flow 1000, or other operations may be added to the process flow 1000. Further, although some operations or signaling may be shown to occur at different times for discussion purposes, these operations may actually occur at the same time or otherwise concurrently.

At 1005, the UE 115 may receive, from the base station 105, at least one control message identifying a first SS set and a third SS set for a first cell (e.g., a P(S)Cell) and a second SS set for a second cell (e.g., an SCell). In some examples, the third SS set for the first cell may be linked, for cross-carrier scheduling of the first cell by the second cell, with the second SS set for the second cell. For example, the third SS set and the second SS set may have matching IDs that link them for cross-carrier scheduling purposes. In some examples, the at least one control message may be an example of one or more control messages associated with one or more SS configurations and may include one or more parameters for each SS set configured for the first cell or the second cell.

At 1010, the UE 115 may monitor the first cell over the first SS set for first control messages associated with scheduling of communication for the first cell. For example, the first SS set on the first cell may be a self-scheduling SS set carrying control messages that schedule future communication also to be communicated on the first cell.

At 1015, the UE 115 may monitor the second cell over the second SS set for second control messages associated with scheduling of communication for the first cell. For example, the second SS on the second cell may be a cross-carrier scheduling SS set carrying control messages that schedule future communication to be communicated on the first cell. In some examples, monitoring the second cell over the second SS set is based on the linking of the second SS set with the third SS set. For example, the linking between the second SS set and the third SS set may identify, label, mark, or otherwise associated the second SS set as being for cross-carrier scheduling.

At 1020, the UE 115 may, in some implementations, suppress monitoring of the first cell over the third SS set that is linked with the second SS set for cross-carrier scheduling. In some examples, the UE 115 may suppress monitoring of the first cell over the third SS based on (e.g., as a result of or because of) the linking between the second SS set and the third SS set. In some other examples, the UE 115 may suppress monitoring of the first cell over the third SS set based on a condition associated with the third SS set not being satisfied. Such a condition associated with the third SS set may be based on a presence or a configuration of one or more parameters associated with the third SS set, where an absence of or lack of configuration for the one or more parameters may be associated with the condition not being satisfied. Additionally or alternatively, the UE 115 may suppress monitoring of the first cell over the third SS set in accordance with a parameter exclusively configured to indicate whether the UE 115 is to monitor the third SS set indicating that the UE 115 is to suppress monitoring of the third SS set.

At 1025, the UE 115 may, in some other implementations, monitor the first cell over the third SS set that is linked with the second SS set for cross-carrier scheduling. In some examples, the UE 115 may monitor the first cell over the third SS set based on a condition associated with the third SS set being satisfied. Such a condition associated with the third SS set may be based on a presence or a configuration of one or more parameters associated with the third SS set, where a presence of or configuration for the one or more parameters may be associated with the condition being satisfied. Additionally or alternatively, the UE 115 may monitor the first cell over the third SS set in accordance with a parameter exclusively configured to indicate whether the UE 115 is to monitor the third SS set indicating that the UE 115 is to monitor the third SS set.

At 1030, the UE 115 and the base station 105 may communicate on the first cell based on the first control messages or the second control messages, or both. For example, the UE 115 and the base station 105 may communicate (via uplink or downlink, or both) one or more data messages scheduled on the first cell by the first control messages or the second control messages, or both. In some aspects, the UE 115 and the base station 105 may additionally communicate on the second cell (e.g., if the UE 115 also monitors over an SS set on the second cell configured for self-scheduling on the second cell).

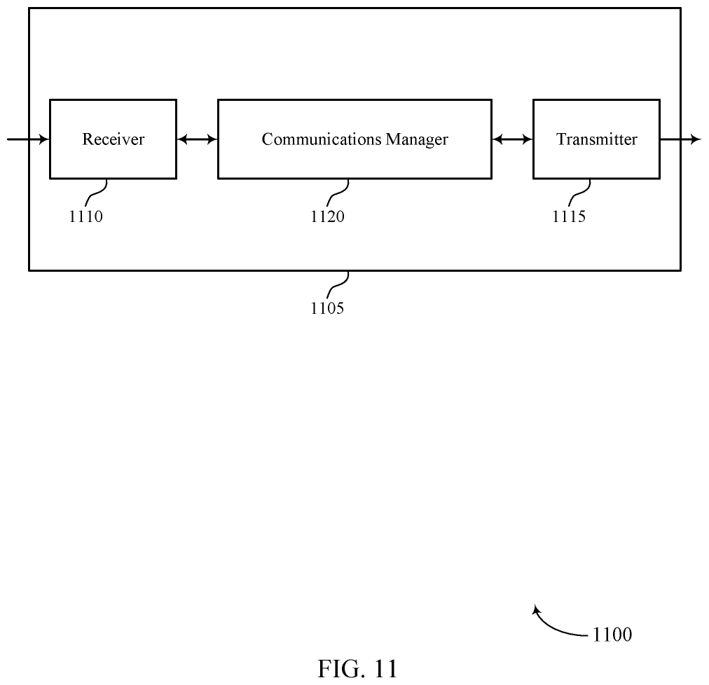

FIG. 11 shows a block diagram 1100 of a device 1105 that supports techniques for cross-carrier scheduling from an SCell to a PCell in accordance with aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for cross-carrier scheduling from an SCell to a PCell). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for cross-carrier scheduling from an SCell to a PCell). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of techniques for cross-carrier scheduling from an SCell to a PCell as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a UE in accordance with examples as disclosed herein. For example, the communications manager 1120 may be configured as or otherwise support a means for receiving at least one control message identifying a first SS set and a third SS set for a first cell and a second SS set for a second cell, where the third SS set for the first cell is linked, for cross-carrier scheduling of the first cell by the second cell, with the second SS set for the second cell. The communications manager 1120 may be configured as or otherwise support a means for monitoring the first cell over the first SS set for first control messages associated with scheduling of communication for the first cell. The communications manager 1120 may be configured as or otherwise support a means for monitoring the second cell over the second SS set for second control messages associated with scheduling of communication for the first cell, where monitoring the second cell over the second SS set is based on the linking of the second SS set with the third SS set. The communications manager 1120 may be configured as or otherwise support a means for communicating over the first cell based on the first control messages or the second control messages.

The communications manager 1120 may support wireless communication at a UE in accordance with examples as disclosed herein. For example, the communications manager 1120 may be configured as or otherwise support a means for receiving one or more control messages identifying a first search space set for a first cell and a second search space set for a second cell, where the first search space set for the first cell is linked, for cross-carrier scheduling of the first cell by the second cell, with the second search space set for the second cell, and where the one or more control messages include a first parameter indicating whether to monitor for uplink grants, downlink grants, or both, for the first cell and include a second parameter indicating whether to monitor for uplink grants, downlink grants, or both, for the second cell. The communications manager 1120 may be configured as or otherwise support a means for monitoring, based on the first parameter and the second parameter, the first cell over one of the first search space set or a third search space set for one of the uplink grants or the downlink grants and the second cell over the second search space set for the other one of the uplink grants or the downlink grants. The communications manager 1120 may be configured as or otherwise support a means for communicating over the first cell based on the uplink grants or the downlink grants, or both.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for reduced processing, reduced power consumption, and more efficient utilization of communication resources.

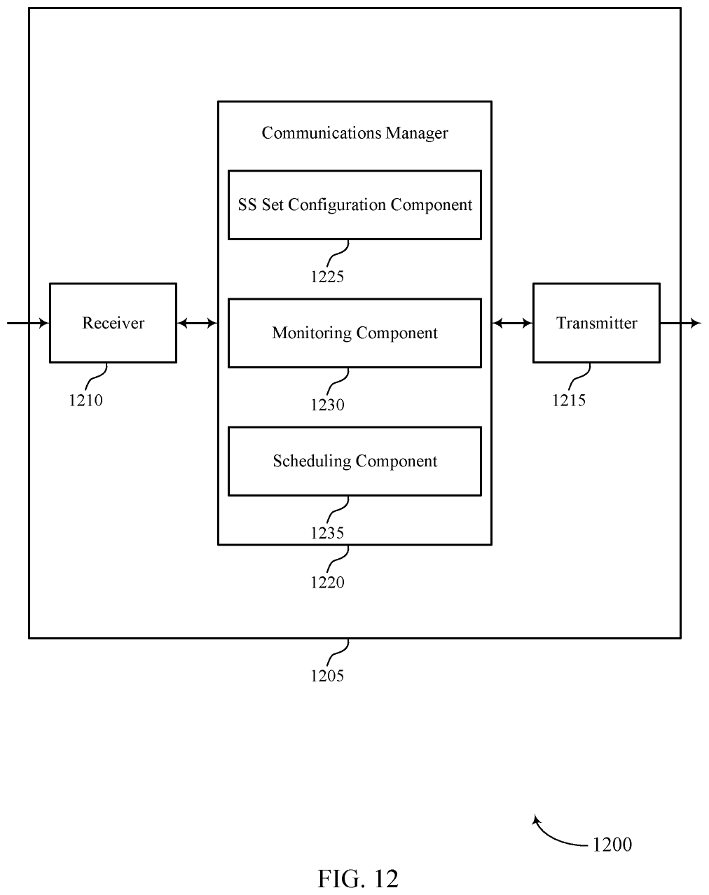

FIG. 12 shows a block diagram 1200 of a device 1205 that supports techniques for cross-carrier scheduling from an SCell to a PCell in accordance with aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for cross-carrier scheduling from an SCell to a PCell). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for cross-carrier scheduling from an SCell to a PCell). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of techniques for cross-carrier scheduling from an SCell to a PCell as described herein. For example, the communications manager 1220 may include an SS set configuration component 1225, a monitoring component 1230, a scheduling component 1235, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a UE in accordance with examples as disclosed herein. The SS set configuration component 1225 may be configured as or otherwise support a means for receiving at least one control message identifying a first SS set and a third SS set for a first cell and a second SS set for a second cell, where the third SS set for the first cell is linked, for cross-carrier scheduling of the first cell by the second cell, with the second SS set for the second cell. The monitoring component 1230 may be configured as or otherwise support a means for monitoring the first cell over the first SS set for first control messages associated with scheduling of communication for the first cell. The monitoring component 1230 may be configured as or otherwise support a means for monitoring the second cell over the second SS set for second control messages associated with scheduling of communication for the first cell, where monitoring the second cell over the second SS set is based on the linking of the second SS set with the third SS set. The scheduling component 1235 may be configured as or otherwise support a means for communicating over the first cell based on the first control messages or the second control messages.

The communications manager 1220 may support wireless communication at a UE in accordance with examples as disclosed herein. The SS set configuration component 1225 may be configured as or otherwise support a means for receiving one or more control messages identifying a first search space set for a first cell and a second search space set for a second cell, where the first search space set for the first cell is linked, for cross-carrier scheduling of the first cell by the second cell, with the second search space set for the second cell, and where the one or more control messages include a first parameter indicating whether to monitor for uplink grants, downlink grants, or both, for the first cell and include a second parameter indicating whether to monitor for uplink grants, downlink grants, or both, for the second cell. The monitoring component 1230 may be configured as or otherwise support a means for monitoring, based on the first parameter and the second parameter, the first cell over one of the first search space set or a third search space set for one of the uplink grants or the downlink grants and the second cell over the second search space set for the other one of the uplink grants or the downlink grants. The scheduling component 1235 may be configured as or otherwise support a means for communicating over the first cell based on the uplink grants or the downlink grants, or both.

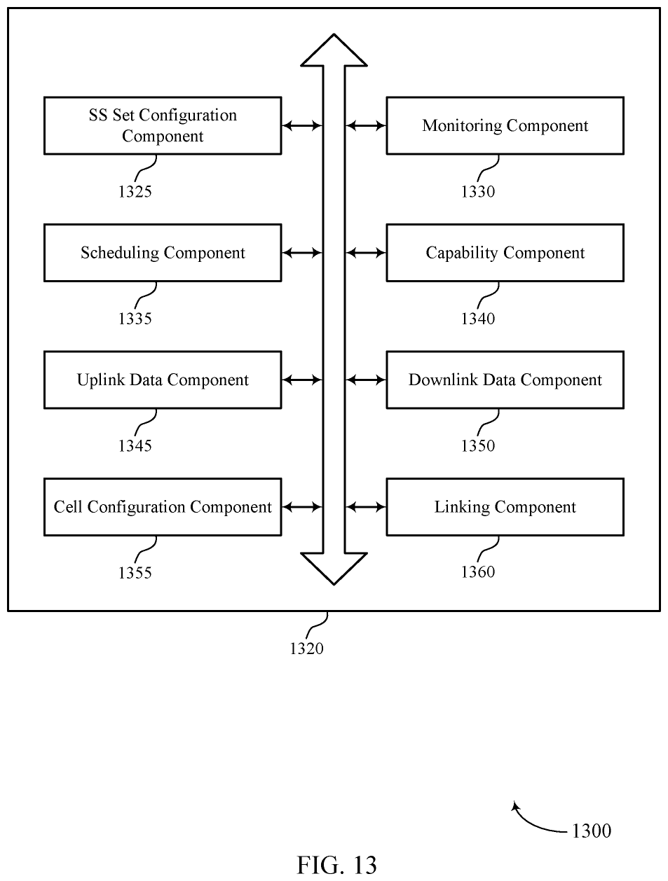

FIG. 13 shows a block diagram 1300 of a communications manager 1320 that supports techniques for cross-carrier scheduling from an SCell to a PCell in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of techniques for cross-carrier scheduling from an SCell to a PCell as described herein. For example, the communications manager 1320 may include an SS set configuration component 1325, a monitoring component 1330, a scheduling component 1335, a capability component 1340, an uplink data component 1345, a downlink data component 1350, a cell configuration component 1355, or any combination thereof. Each of these components may communicate, directly or indirectly, with one another (e.g., via one or more buses).

The communications manager 1320 may support wireless communication at a UE in accordance with examples as disclosed herein. The SS set configuration component 1325 may be configured as or otherwise support a means for receiving at least one control message identifying a first SS set and a third SS set for a first cell and a second SS set for a second cell, where the third SS set for the first cell is linked, for cross-carrier scheduling of the first cell by the second cell, with the second SS set for the second cell. The monitoring component 1330 may be configured as or otherwise support a means for monitoring the first cell over the first SS set for first control messages associated with scheduling of communication for the first cell. In some examples, the monitoring component 1330 may be configured as or otherwise support a means for monitoring the second cell over the second SS set for second control messages associated with scheduling of communication for the first cell, where monitoring the second cell over the second SS set is based on the linking of the second SS set with the third SS set. The scheduling component 1335 may be configured as or otherwise support a means for communicating over the first cell based on the first control messages or the second control messages.

In some examples, the monitoring component 1330 may be configured as or otherwise support a means for suppressing monitoring of the first cell over the third SS set that is linked with the second SS set for cross-carrier scheduling based on the linking of the second SS set with the third SS set.

In some examples, the monitoring component 1330 may be configured as or otherwise support a means for monitoring the first cell over the third SS set that is linked with the second SS set for cross-carrier scheduling if a condition associated with the third SS set is satisfied. In some examples, the monitoring component 1330 may be configured as or otherwise support a means for suppressing monitoring of the first cell over the third SS set that is linked with the second SS set if the condition with the third SS set is not satisfied.

In some examples, the SS set configuration component 1325 may be configured as or otherwise support a means for receiving, via the at least one control message, an indication of a control resource set ID associated with the third SS set, where receiving the indication of the control resource set ID associated with the third SS set satisfies the condition.

In some examples, the SS set configuration component 1325 may be configured as or otherwise support a means for receiving, via the at least one control message, an indication of a type of the third SS set, where receiving the indication of the type of the third SS set satisfies the condition.

In some examples, the SS set configuration component 1325 may be configured as or otherwise support a means for receiving, via the at least one control message, a bitmap indicating a set of symbols during which to monitor over the third SS set, where receiving the bitmap indicating the set of symbols during which to monitor over the third SS set satisfies the condition.

In some examples, the SS set configuration component 1325 may be configured as or otherwise support a means for receiving, via the at least one control message, a parameter exclusively configured for indicating whether to monitor over the third SS set.

In some examples, the monitoring component 1330 may be configured as or otherwise support a means for monitoring the first cell over the third SS set that is linked with the second SS set for cross-carrier scheduling based on the parameter indicating that the UE is to monitor over the third SS set. In some examples, the monitoring component 1330 may be configured as or otherwise support a means for suppressing monitoring of the first cell over the third SS set that is linked with the second SS set for cross-carrier scheduling based on the parameter indicating that the UE is to refrain from monitoring over the third SS set.

In some examples, to support monitoring the second cell over the second SS set for the second control messages associated with scheduling of communication for the first cell, the linking component 1360 may be configured as or otherwise support a means for monitoring over a quantity of PDCCH candidates based on the at least one control message identifying the third SS set with the quantity of PDCCH candidates and the linking of the second SS set with the third SS set.

In some examples, to support communicating on at least the first cell based on the first control messages or the second control messages, the downlink data component 1350 may be configured as or otherwise support a means for receiving a downlink shared channel message based on scheduling information in the first control messages or the second control messages.

In some examples, the cell configuration component 1355 may be configured as or otherwise support a means for receiving a control message indicating that the second cell is a scheduling cell for the first cell, where the first cell includes a PCell or a PSCell and the second cell includes an SCell.

The communications manager 1320 may support wireless communication at a UE in accordance with examples as disclosed herein. The SS set configuration component 1325 may be configured as or otherwise support a means for receiving one or more control messages identifying a first search space set for a first cell and a second search space set for a second cell, where the first search space set for the first cell is linked, for cross-carrier scheduling of the first cell by the second cell, with the second search space set for the second cell, and where the one or more control messages include a first parameter indicating whether to monitor for uplink grants, downlink grants, or both, for the first cell and include a second parameter indicating whether to monitor for uplink grants, downlink grants, or both, for the second cell. The monitoring component 1330 may be configured as or otherwise support a means for monitoring, based on the first parameter and the second parameter, the first cell over one of the first search space set or a third search space set for one of the uplink grants or the downlink grants and the second cell over the second search space set for the other one of the uplink grants or the downlink grants. The scheduling component 1335 may be configured as or otherwise support a means for communicating over the first cell based on the uplink grants or the downlink grants, or both.

In some examples, to support monitoring, the monitoring component 1330 may be configured as or otherwise support a means for monitoring the first cell over the first search space set for the first subset of the set of control information formats and the second cell over the second search space set for the second subset of the set of control information formats.

In some examples, to support monitoring, the monitoring component 1330 may be configured as or otherwise support a means for monitoring the first cell over the third search space set for the first subset of the set of control information formats and the second cell over the second search space set for the second subset of the set of control information formats.

In some examples, a number of decoding candidates for monitoring for the second cell over the second search space set is indicated in a third parameter of a configuration for the first search space set.

In some examples, to support monitoring, the monitoring component 1330 may be configured as or otherwise support a means for monitoring the first cell over the first search space set for a first subset of a set of control information formats and the second cell over the second search space set for a second subset of the set of control information formats.

In some examples, the capability component 1340 may be configured as or otherwise support a means for transmitting, to a base station, an indication that a capability of the UE is associated with monitoring of the first cell for both the uplink grants and the downlink grants and the second cell for both the uplink grants and the downlink grants over non-overlapping monitoring occasions, where the monitoring includes. In some examples, the monitoring component 1330 may be configured as or otherwise support a means for monitoring the first cell over the first search space set for the one of the uplink grants or the downlink grants in a first set of monitoring occasions and the second cell over the second search space set for the other one of the uplink grants or the downlink grants in a second set of monitoring occasions, where the first set of monitoring occasions overlap in time with the second set of monitoring occasions.

In some examples, to support communicating on at least the first cell based on the uplink grants or the downlink grants, or both, the uplink data component 1345 may be configured as or otherwise support a means for transmitting an uplink data message based on first scheduling information in the uplink grants. In some examples, to support communicating on at least the first cell based on the uplink grants or the downlink grants, or both, the downlink data component 1350 may be configured as or otherwise support a means for receiving a downlink data message based on second scheduling information in the downlink grants.

In some examples, the cell configuration component 1355 may be configured as or otherwise support a means for receiving a control message indicating that the second cell is a scheduling cell for the first cell, where the first cell includes a PCell or a PSCell and the second cell includes an SCell.

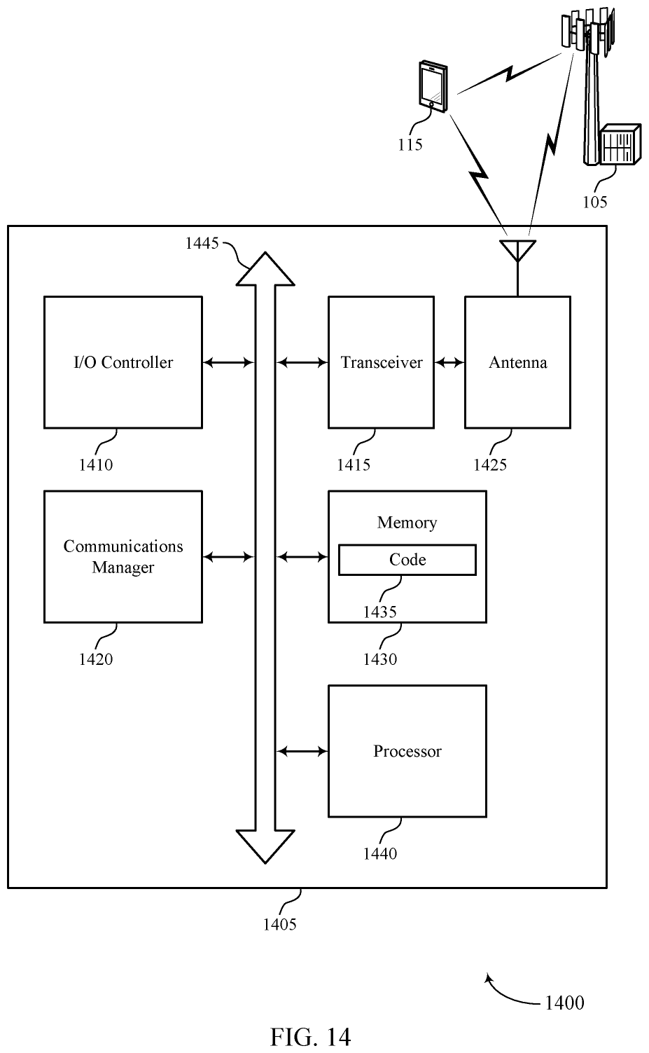

FIG. 14 shows a diagram of a system 1400 including a device 1405 that supports techniques for cross-carrier scheduling from an SCell to a PCell in accordance with aspects of the present disclosure. The device 1405 may be an example of or include the components of a device 1105, a device 1205, or a UE 115 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting techniques for cross-carrier scheduling from an SCell to a PCell). For example, the device 1405 or a component of the device 1405 may include a processor 1440 and memory 1430 coupled to the processor 1440, the processor 1440 and memory 1430 configured to perform various functions described herein.

The communications manager 1420 may support wireless communication at a UE in accordance with examples as disclosed herein. For example, the communications manager 1420 may be configured as or otherwise support a means for receiving at least one control message identifying a first SS set and a third SS set for a first cell and a second SS set for a second cell, where the third SS set for the first cell is linked, for cross-carrier scheduling of the first cell by the second cell, with the second SS set for the second cell. The communications manager 1420 may be configured as or otherwise support a means for monitoring the first cell over the first SS set for first control messages associated with scheduling of communication for the first cell. The communications manager 1420 may be configured as or otherwise support a means for monitoring the second cell over the second SS set for second control messages associated with scheduling of communication for the first cell, where monitoring the second cell over the second SS set is based on the linking of the second SS set with the third SS set. The communications manager 1420 may be configured as or otherwise support a means for communicating over the first cell based on the first control messages or the second control messages.

The communications manager 1420 may support wireless communication at a UE in accordance with examples as disclosed herein. For example, the communications manager 1420 may be configured as or otherwise support a means for receiving one or more control messages identifying a first search space set for a first cell and a second search space set for a second cell, where the first search space set for the first cell is linked, for cross-carrier scheduling of the first cell by the second cell, with the second search space set for the second cell, and where the one or more control messages include a first parameter indicating whether to monitor for uplink grants, downlink grants, or both, for the first cell and include a second parameter indicating whether to monitor for uplink grants, downlink grants, or both, for the second cell. The communications manager 1420 may be configured as or otherwise support a means for monitoring, based on the first parameter and the second parameter, the first cell over one of the first search space set or a third search space set for one of the uplink grants or the downlink grants and the second cell over the second search space set for the other one of the uplink grants or the downlink grants. The communications manager 1420 may be configured as or otherwise support a means for communicating over the first cell based on the uplink grants or the downlink grants, or both.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of techniques for cross-carrier scheduling from an SCell to a PCell as described herein, or the processor 1440 and the memory 1430 may be otherwise configured to perform or support such operations.

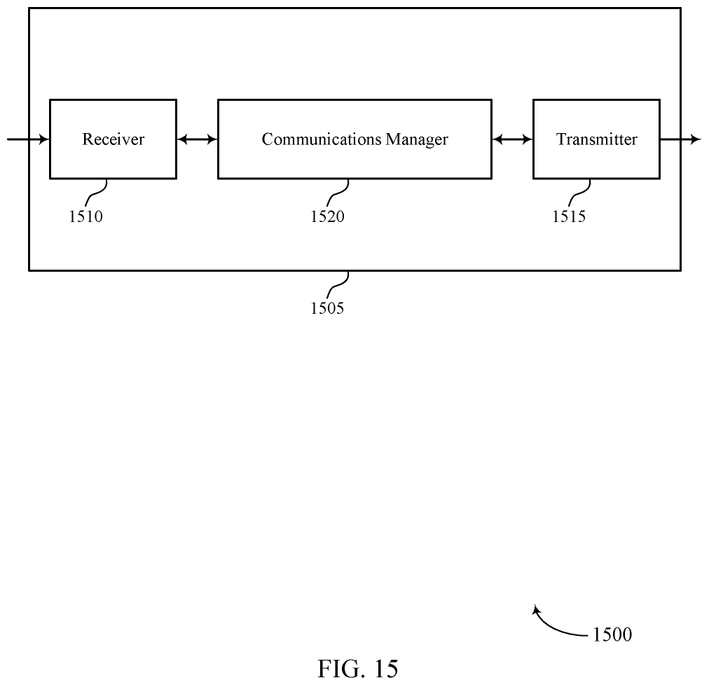

FIG. 15 shows a block diagram 1500 of a device 1505 that supports techniques for cross-carrier scheduling from an SCell to a PCell in accordance with aspects of the present disclosure. The device 1505 may be an example of aspects of a base station 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to techniques for cross-carrier scheduling from an SCell to a PCell). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to techniques for cross-carrier scheduling from an SCell to a PCell). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of techniques for cross-carrier scheduling from an SCell to a PCell as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1520 may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communication at a base station in accordance with examples as disclosed herein. For example, the communications manager 1520 may be configured as or otherwise support a means for transmitting, to a UE, at least one control message identifying a first SS set and a third SS set for a first cell and a second SS set for a second cell, where the third SS set for the first cell is linked, for cross-carrier scheduling of the first cell by the second cell, with the second SS set for the second cell. The communications manager 1520 may be configured as or otherwise support a means for transmitting, to the UE on the first cell over the first SS set, first control messages associated with scheduling of communication for the first cell. The communications manager 1520 may be configured as or otherwise support a means for transmitting, to the UE on the second cell over the second SS set, second control messages associated with scheduling of communication for the first cell, where transmitting the second control messages on the second cell over the second SS set is based on the linking of the second SS set with the third SS set. The communications manager 1520 may be configured as or otherwise support a means for communicating with the UE on at least the first cell based on the first control messages or the second control messages.

The communications manager 1520 may support wireless communication at a base station in accordance with examples as disclosed herein. For example, the communications manager 1520 may be configured as or otherwise support a means for transmitting, to a UE, one or more control messages identifying a first search space set for a first cell and a second search space set for a second cell, where the first search space set for the first cell is linked, for cross-carrier scheduling of the first cell by the second cell, with the second search space set for the second cell, and where the one or more control messages include a first parameter indicating whether to monitor for uplink grants, downlink grants, or both, for the first cell and include a second parameter indicating whether to monitor for uplink grants, downlink grants, or both, for the second cell. The communications manager 1520 may be configured as or otherwise support a means for transmitting, to the UE on the first cell over one of the first search space set or a third search space set, one of the uplink grants or the downlink grants in accordance with the first parameter and, to the UE on the second cell over the second search space set, the other one of the uplink grants or the downlink grants in accordance with the second parameter. The communications manager 1520 may be configured as or otherwise support a means for communicating with the UE on at least the first cell based on the uplink grants or the downlink grants, or both.

By including or configuring the communications manager 1520 in accordance with examples as described herein, the device 1505 (e.g., a processor controlling or otherwise coupled to the receiver 1510, the transmitter 1515, the communications manager 1520, or a combination thereof) may support techniques for reduced processing, reduced power consumption, and more efficient utilization of communication resources.

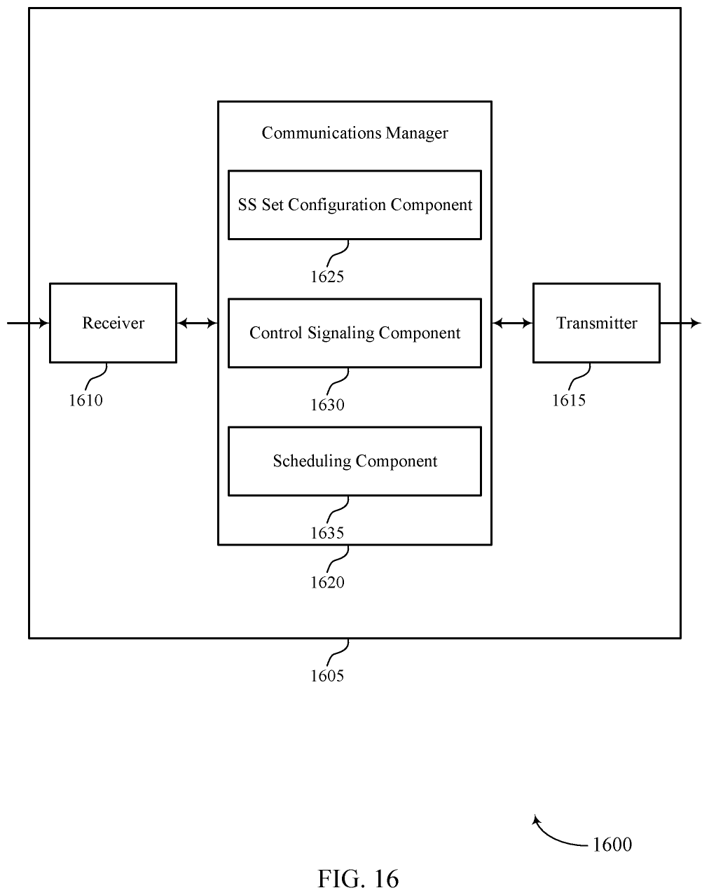

FIG. 16 shows a block diagram 1600 of a device 1605 that supports techniques for cross-carrier scheduling from an SCell to a PCell in accordance with aspects of the present disclosure. The device 1605 may be an example of aspects of a device 1505 or a base station 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to techniques for cross-carrier scheduling from an SCell to a PCell). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to techniques for cross-carrier scheduling from an SCell to a PCell). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of techniques for cross-carrier scheduling from an SCell to a PCell as described herein. For example, the communications manager 1620 may include an SS set configuration component 1625, a control signaling component 1630, a scheduling component 1635, or any combination thereof. The communications manager 1620 may be an example of aspects of a communications manager 1520 as described herein. In some examples, the communications manager 1620, or various components thereof, may be configured to perform various operations (e.g., receiving, monitoring, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to receive information, transmit information, or perform various other operations as described herein.

The communications manager 1620 may support wireless communication at a base station in accordance with examples as disclosed herein. The SS set configuration component 1625 may be configured as or otherwise support a means for transmitting, to a UE, at least one control message identifying a first SS set and a third SS set for a first cell and a second SS set for a second cell, where the third SS set for the first cell is linked, for cross-carrier scheduling of the first cell by the second cell, with the second SS set for the second cell. The control signaling component 1630 may be configured as or otherwise support a means for transmitting, to the UE on the first cell over the first SS set, first control messages associated with scheduling of communication for the first cell. The control signaling component 1630 may be configured as or otherwise support a means for transmitting, to the UE on the second cell over the second SS set, second control messages associated with scheduling of communication for the first cell, where transmitting the second control messages on the second cell over the second SS set is based on the linking of the second SS set with the third SS set. The scheduling component 1635 may be configured as or otherwise support a means for communicating with the UE on at least the first cell based on the first control messages or the second control messages.

The communications manager 1620 may support wireless communication at a base station in accordance with examples as disclosed herein. The SS set configuration component 1625 may be configured as or otherwise support a means for transmitting, to a UE, one or more control messages identifying a first search space set for a first cell and a second search space set for a second cell, where the first search space set for the first cell is linked, for cross-carrier scheduling of the first cell by the second cell, with the second search space set for the second cell, and where the one or more control messages include a first parameter indicating whether to monitor for uplink grants, downlink grants, or both, for the first cell and include a second parameter indicating whether to monitor for uplink grants, downlink grants, or both, for the second cell. The control signaling component 1630 may be configured as or otherwise support a means for transmitting, to the UE on the first cell over one of the first search space set or a third search space set, one of the uplink grants or the downlink grants in accordance with the first parameter and, to the UE on the second cell over the second search space set, the other one of the uplink grants or the downlink grants in accordance with the second parameter. The scheduling component 1635 may be configured as or otherwise support a means for communicating with the UE on at least the first cell based on the uplink grants or the downlink grants, or both.

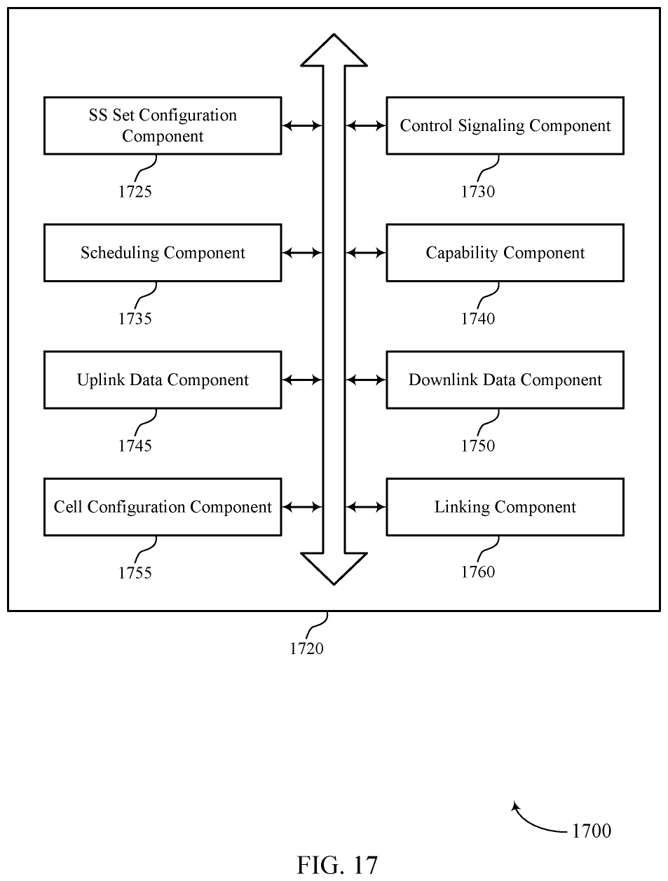

FIG. 17 shows a block diagram 1700 of a communications manager 1720 that supports techniques for cross-carrier scheduling from an SCell to a PCell in accordance with aspects of the present disclosure. The communications manager 1720 may be an example of aspects of a communications manager 1520, a communications manager 1620, or both, as described herein. The communications manager 1720, or various components thereof, may be an example of means for performing various aspects of techniques for cross-carrier scheduling from an SCell to a PCell as described herein. For example, the communications manager 1720 may include an SS set configuration component 1725, a control signaling component 1730, a scheduling component 1735, a capability component 1740, an uplink data component 1745, a downlink data component 1750, a cell configuration component 1755, or any combination thereof. Each of these components may communicate, directly or indirectly, with one another (e.g., via one or more buses).

The communications manager 1720 may support wireless communication at a base station in accordance with examples as disclosed herein. The SS set configuration component 1725 may be configured as or otherwise support a means for transmitting, to a UE, at least one control message identifying a first SS set and a third SS set for a first cell and a second SS set for a second cell, where the third SS set for the first cell is linked, for cross-carrier scheduling of the first cell by the second cell, with the second SS set for the second cell. The control signaling component 1730 may be configured as or otherwise support a means for transmitting, to the UE on the first cell over the first SS set, first control messages associated with scheduling of communication for the first cell. In some examples, the control signaling component 1730 may be configured as or otherwise support a means for transmitting, to the UE on the second cell over the second SS set, second control messages associated with scheduling of communication for the first cell, where transmitting the second control messages on the second cell over the second SS set is based on the linking of the second SS set with the third SS set. The scheduling component 1735 may be configured as or otherwise support a means for communicating with the UE on at least the first cell based on the first control messages or the second control messages.

In some examples, the control signaling component 1730 may be configured as or otherwise support a means for suppressing transmitting control messages to the UE on the first cell over the third SS set that is linked with the second SS set for cross-carrier scheduling based on the linking of the second SS set with the third SS set.

In some examples, the control signaling component 1730 may be configured as or otherwise support a means for transmitting one or more control messages to the UE on the first cell over the third SS set that is linked with the second SS set for cross-carrier scheduling if a condition associated with the third SS set is satisfied. In some examples, the control signaling component 1730 may be configured as or otherwise support a means for suppressing transmitting the one or more control messages to the UE on the first cell over the third SS set that is linked with the second SS set for cross-carrier scheduling if the condition associated with the third SS set is not satisfied.

In some examples, the SS set configuration component 1725 may be configured as or otherwise support a means for transmitting, via the at least one control message, an indication of a control resource set ID associated with the third SS set, where transmitting the indication of the control resource set ID associated with the third SS set satisfies the condition.

In some examples, the SS set configuration component 1725 may be configured as or otherwise support a means for transmitting, via the at least one control message, an indication of a type of the third SS set, where transmitting the indication of the type of the third SS set satisfies the condition.

In some examples, the SS set configuration component 1725 may be configured as or otherwise support a means for transmitting, via the at least one control message, a bitmap indicating a set of symbols during which the UE is to monitor over the third SS set, where transmitting the bitmap indicating the set of symbols during which the UE is to monitor over the third SS set satisfies the condition.

In some examples, the SS set configuration component 1725 may be configured as or otherwise support a means for transmitting, via the at least one control message, a parameter exclusively configured for indicating whether the UE is to monitor over the third SS set.

In some examples, the control signaling component 1730 may be configured as or otherwise support a means for transmitting on the first cell over the third SS set that is linked with the second SS set for cross-carrier scheduling based on the parameter indicating that the UE is to monitor over the third SS set. In some examples, the control signaling component 1730 may be configured as or otherwise support a means for suppressing transmitting on the first cell over the third SS set that is linked with the second SS set for cross-carrier scheduling based on the parameter indicating that the UE is to refrain from monitoring over the third SS set.

In some examples, to support transmitting the second control messages to the UE on the second cell over the second SS set, the linking component 1760 may be configured as or otherwise support a means for transmitting over at least a subset of a quantity of PDCCH candidates, the quantity of PDCCH candidates based on the at least one control message identifying the third SS set with the quantity of PDCCH candidates and the linking of the second SS set with the third SS set.

In some examples, to support communicating with the UE on at least the first cell based on the first control messages or the second control messages, the downlink data component 1750 may be configured as or otherwise support a means for transmitting a downlink shared channel message based on scheduling information in the first control messages or the second control messages.

In some examples, the cell configuration component 1755 may be configured as or otherwise support a means for transmitting a control message indicating that the second cell is a scheduling cell for the first cell, where the first cell includes a PCell or a PSCell and the second cell includes an SCell.

The communications manager 1720 may support wireless communication at a base station in accordance with examples as disclosed herein. The SS set configuration component 1725 may be configured as or otherwise support a means for transmitting, to a UE, one or more control messages identifying a first search space set for a first cell and a second search space set for a second cell, where the first search space set for the first cell is linked, for cross-carrier scheduling of the first cell by the second cell, with the second search space set for the second cell, and where the one or more control messages include a first parameter indicating whether to monitor for uplink grants, downlink grants, or both, for the first cell and include a second parameter indicating whether to monitor for uplink grants, downlink grants, or both, for the second cell. The control signaling component 1730 may be configured as or otherwise support a means for transmitting, to the UE on the first cell over one of the first search space set or a third search space set, one of the uplink grants or the downlink grants in accordance with the first parameter and, to the UE on the second cell over the second search space set, the other one of the uplink grants or the downlink grants in accordance with the second parameter. The scheduling component 1735 may be configured as or otherwise support a means for communicating with the UE on at least the first cell based on the uplink grants or the downlink grants, or both.

In some examples, to support transmitting the one of the uplink grants or the downlink grants on the first cell and the other one of the uplink grants or the downlink grants on the second cell, the control signaling component 1730 may be configured as or otherwise support a means for transmitting, on the first cell over the first search space set, first control information in accordance with the first subset of the set of control information formats and, on the second cell over the second search space set, second control information in accordance with the second subset of the set of control information formats.

In some examples, to support transmitting the one of the uplink grants or the downlink grants on the first cell and the other one of the uplink grants or the downlink grants on the second cell, the control signaling component 1730 may be configured as or otherwise support a means for transmitting, on the first cell over the third search space set, first control information in accordance with the first subset of the set of control information formats and, on the second cell over the second search space set, second control information in accordance with the second subset of the set of control information formats.

In some examples, a number of decoding candidates for monitoring, by the UE, for the second cell over the second search space set is indicated in a third parameter of a configuration for the first search space set.

In some examples, to support transmitting the one of the uplink grants or the downlink grants on the first cell and the other one of the uplink grants or the downlink grants on the second cell, the control signaling component 1730 may be configured as or otherwise support a means for transmitting, on the first cell over the first search space set, first control information in accordance with a first subset of a set of control information formats and, the second cell over the second search space set, second control information in accordance with a second subset of the set of control information formats.

In some examples, the capability component 1740 may be configured as or otherwise support a means for receiving, from the UE, an indication that a capability of the UE is associated with monitoring of the first cell for both the uplink grants and the downlink grants and the second cell for both the uplink grants and the downlink grants over non-overlapping monitoring occasions, and where transmitting the one of the uplink grants or the downlink grants on the first cell and the other one of the uplink grants or the downlink grants on the second cell includes. In some examples, the control signaling component 1730 may be configured as or otherwise support a means for transmitting, on the first cell over the first search space set, the one of the uplink grants or the downlink grants in a first set of monitoring occasions and, on the second cell over the second search space set, the other one of the uplink grants or the downlink grants in a second set of monitoring occasions, where the first set of monitoring occasions overlap in time with the second set of monitoring occasions.

In some examples, to support communicating with the UE on at least the first cell based on the uplink grants or the downlink grants, or both, the uplink data component 1745 may be configured as or otherwise support a means for receiving an uplink data message based on first scheduling information in the uplink grants. In some examples, to support communicating with the UE on at least the first cell based on the uplink grants or the downlink grants, or both, the downlink data component 1750 may be configured as or otherwise support a means for transmitting a downlink data message based on second scheduling information in the downlink grants.

In some examples, the cell configuration component 1755 may be configured as or otherwise support a means for transmitting a control message indicating that the second cell is a scheduling cell for the first cell, where the first cell includes a PCell or a PSCell and the second cell includes an SCell.

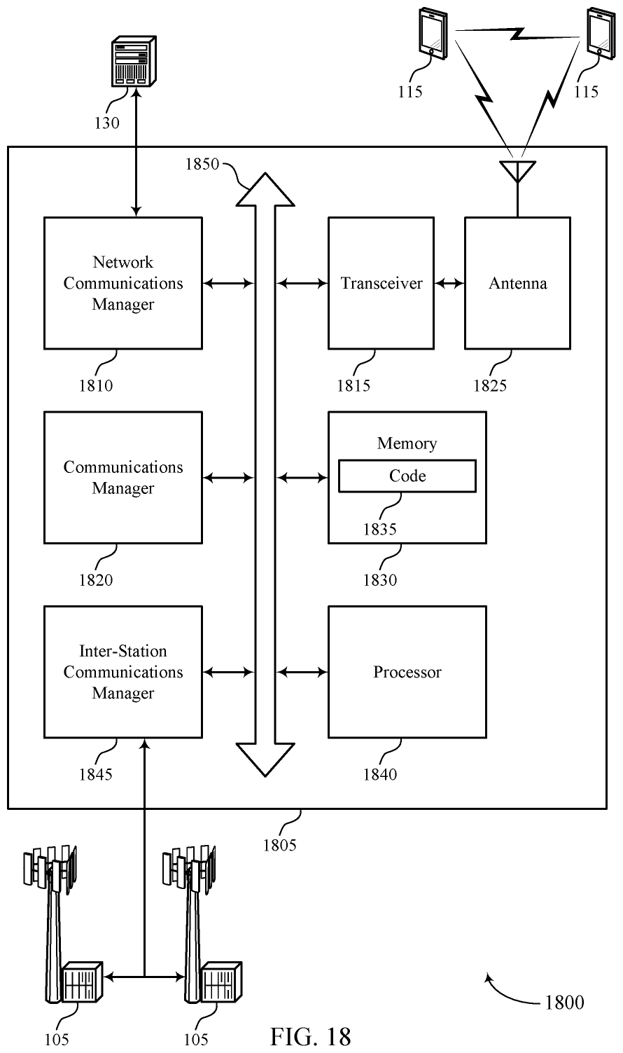

FIG. 18 shows a diagram of a system 1800 including a device 1805 that supports techniques for cross-carrier scheduling from an SCell to a PCell in accordance with aspects of the present disclosure. The device 1805 may be an example of or include the components of a device 1505, a device 1605, or a base station 105 as described herein. The device 1805 may communicate wirelessly with one or more base stations 105, UEs 115, or any combination thereof. The device 1805 may include components for bi-directional voice and data communications including components for transmitting and receiving communications, such as a communications manager 1820, a network communications manager 1810, a transceiver 1815, an antenna 1825, a memory 1830, code 1835, a processor 1840, and an inter-station communications manager 1845. These components may be in electronic communication or otherwise coupled (e.g., operatively, communicatively, functionally, electronically, electrically) via one or more buses (e.g., a bus 1850).

The network communications manager 1810 may manage communications with a core network 130 (e.g., via one or more wired backhaul links). For example, the network communications manager 1810 may manage the transfer of data communications for client devices, such as one or more UEs 115.

In some cases, the device 1805 may include a single antenna 1825. However, in some other cases the device 1805 may have more than one antenna 1825, which may be capable of concurrently transmitting or receiving multiple wireless transmissions. The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The memory 1830 may include RAM and ROM. The memory 1830 may store computer-readable, computer-executable code 1835 including instructions that, when executed by the processor 1840, cause the device 1805 to perform various functions described herein. The code 1835 may be stored in a non-transitory computer-readable medium such as system memory or another type of memory. In some cases, the code 1835 may not be directly executable by the processor 1840 but may cause a computer (e.g., when compiled and executed) to perform functions described herein. In some cases, the memory 1830 may contain, among other things, a BIOS which may control basic hardware or software operation such as the interaction with peripheral components or devices.

The processor 1840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1840 may be configured to operate a memory array using a memory controller. In some other cases, a memory controller may be integrated into the processor 1840. The processor 1840 may be configured to execute computer-readable instructions stored in a memory (e.g., the memory 1830) to cause the device 1805 to perform various functions (e.g., functions or tasks supporting techniques for cross-carrier scheduling from an SCell to a PCell). For example, the device 1805 or a component of the device 1805 may include a processor 1840 and memory 1830 coupled to the processor 1840, the processor 1840 and memory 1830 configured to perform various functions described herein.

The inter-station communications manager 1845 may manage communications with other base stations 105, and may include a controller or scheduler for controlling communications with UEs 115 in cooperation with other base stations 105. For example, the inter-station communications manager 1845 may coordinate scheduling for transmissions to UEs 115 for various interference mitigation techniques such as beamforming or joint transmission. In some examples, the inter-station communications manager 1845 may provide an X2 interface within an LTE/LTE-A wireless communications network technology to provide communication between base stations 105.

The communications manager 1820 may support wireless communication at a base station in accordance with examples as disclosed herein. For example, the communications manager 1820 may be configured as or otherwise support a means for transmitting, to a UE, at least one control message identifying a first SS set and a third SS set for a first cell and a second SS set for a second cell, where the third SS set for the first cell is linked, for cross-carrier scheduling of the first cell by the second cell, with the second SS set for the second cell. The communications manager 1820 may be configured as or otherwise support a means for transmitting, to the UE on the first cell over the first SS set, first control messages associated with scheduling of communication for the first cell. The communications manager 1820 may be configured as or otherwise support a means for transmitting, to the UE on the second cell over the second SS set, second control messages associated with scheduling of communication for the first cell, where transmitting the second control messages on the second cell over the second SS set is based on the linking of the second SS set with the third SS set. The communications manager 1820 may be configured as or otherwise support a means for communicating with the UE on at least the first cell based on the first control messages or the second control messages.

The communications manager 1820 may support wireless communication at a base station in accordance with examples as disclosed herein. For example, the communications manager 1820 may be configured as or otherwise support a means for transmitting, to a UE, one or more control messages identifying a first search space set for a first cell and a second search space set for a second cell, where the first search space set for the first cell is linked, for cross-carrier scheduling of the first cell by the second cell, with the second search space set for the second cell, and where the one or more control messages include a first parameter indicating whether to monitor for uplink grants, downlink grants, or both, for the first cell and include a second parameter indicating whether to monitor for uplink grants, downlink grants, or both, for the second cell. The communications manager 1820 may be configured as or otherwise support a means for transmitting, to the UE on the first cell over one of the first search space set or a third search space set, one of the uplink grants or the downlink grants in accordance with the first parameter and, to the UE on the second cell over the second search space set, the other one of the uplink grants or the downlink grants in accordance with the second parameter. The communications manager 1820 may be configured as or otherwise support a means for communicating with the UE on at least the first cell based on the uplink grants or the downlink grants, or both.

By including or configuring the communications manager 1820 in accordance with examples as described herein, the device 1805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the processor 1840, the memory 1830, the code 1835, or any combination thereof. For example, the code 1835 may include instructions executable by the processor 1840 to cause the device 1805 to perform various aspects of techniques for cross-carrier scheduling from an SCell to a PCell as described herein, or the processor 1840 and the memory 1830 may be otherwise configured to perform or support such operations.

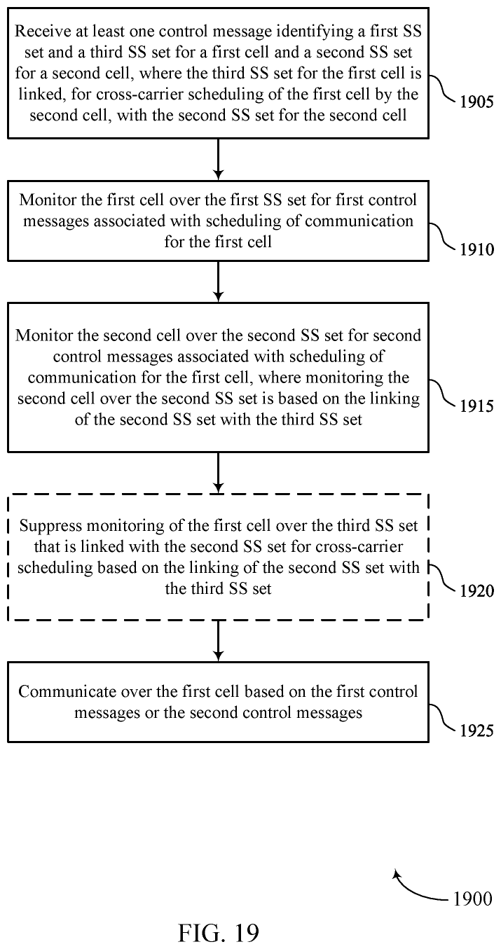

FIG. 19 shows a flowchart illustrating a method 1900 that supports techniques for cross-carrier scheduling from an SCell to a PCell in accordance with aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 1905, the method may include receiving at least one control message identifying a first SS set and a third SS set for a first cell and a second SS set for a second cell, where the third SS set for the first cell is linked, for cross-carrier scheduling of the first cell by the second cell, with the second SS set for the second cell. The operations of 1905 may be performed in accordance with examples as disclosed herein. In some examples, aspects of the operations of 1905 may be performed by one or more components as described herein.

At 1910, the method may include monitoring the first cell over the first SS set for first control messages associated with scheduling of communication for the first cell. The operations of 1910 may be performed in accordance with examples as disclosed herein. In some examples, aspects of the operations of 1910 may be performed by one or more components as described herein.

At 1915, the method may include monitoring the second cell over the second SS set for second control messages associated with scheduling of communication for the first cell, where monitoring the second cell over the second SS set is based on the linking of the second SS set with the third SS set. The operations of 1915 may be performed in accordance with examples as disclosed herein. In some examples, aspects of the operations of 1915 may be performed by one or more components as described herein.

At 1920, the method may include suppressing monitoring of the first cell over the third SS set that is linked with the second SS set for cross-carrier scheduling based on the linking of the second SS set with the third SS set. The operations of 1920 may be performed in accordance with examples as disclosed herein. In some examples, aspects of the operations of 1920 may be performed by one or more components as described herein.

At 1925, the method may include communicating over the first cell based on the first control messages or the second control messages. The operations of 1925 may be performed in accordance with examples as disclosed herein. In some examples, aspects of the operations of 1925 may be performed by one or more components as described herein.

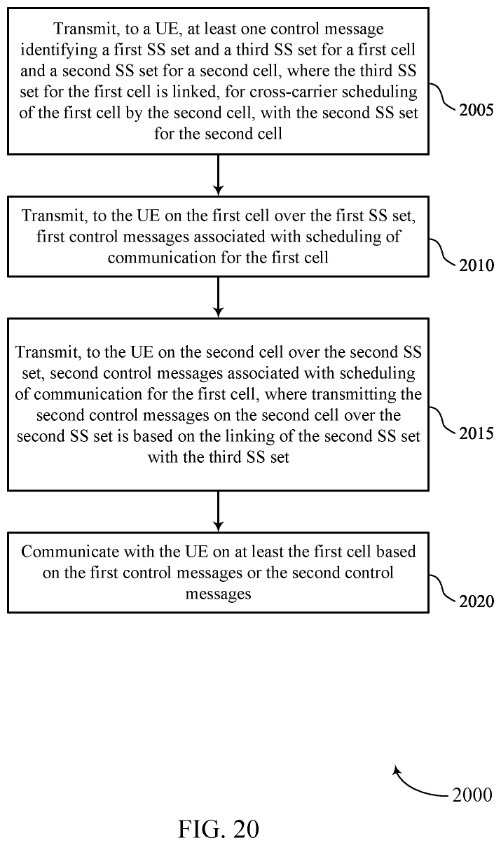

FIG. 20 shows a flowchart illustrating a method 2000 that supports techniques for cross-carrier scheduling from an SCell to a PCell in accordance with aspects of the present disclosure. The operations of the method 2000 may be implemented by a base station or its components as described herein. For example, the operations of the method 2000 may be performed by a base station 105 as described with reference to FIGS. 1 through 9 and 15 through 18. In some examples, a base station may execute a set of instructions to control the functional elements of the base station to perform the described functions. Additionally or alternatively, the base station may perform aspects of the described functions using special-purpose hardware.

At 2005, the method may include transmitting, to a UE, at least one control message identifying a first SS set and a third SS set for a first cell and a second SS set for a second cell, where the third SS set for the first cell is linked, for cross-carrier scheduling of the first cell by the second cell, with the second SS set for the second cell. The operations of 2005 may be performed in accordance with examples as disclosed herein. In some examples, aspects of the operations of 2005 may be performed by one or more components as described herein.

At 2010, the method may include transmitting, to the UE on the first cell over the first SS set, first control messages associated with scheduling of communication for the first cell. The operations of 2010 may be performed in accordance with examples as disclosed herein. In some examples, aspects of the operations of 2010 may be performed by one or more components as described herein.

At 2015, the method may include transmitting, to the UE on the second cell over the second SS set, second control messages associated with scheduling of communication for the first cell, where transmitting the second control messages on the second cell over the second SS set is based on the linking of the second SS set with the third SS set. The operations of 2015 may be performed in accordance with examples as disclosed herein. In some examples, aspects of the operations of 2015 may be performed by one or more components as described herein.

At 2020, the method may include communicating with the UE on at least the first cell based on the first control messages or the second control messages. The operations of 2020 may be performed in accordance with examples as disclosed herein. In some examples, aspects of the operations of 2020 may be performed by one or more components as described herein.

The following provides an overview of aspects of the present disclosure:

Aspect 1: A method for wireless communication at a UE, comprising: receiving at least one control message identifying a first SS set and a third SS set for a first cell and a second SS set for a second cell, wherein the third SS set for the first cell is linked, for cross-carrier scheduling of the first cell by the second cell, with the second SS set for the second cell; monitoring the first cell over the first SS set for first control messages associated with scheduling of communication for the first cell; monitoring the second cell over the second SS set for second control messages associated with scheduling of communication for the first cell, wherein monitoring the second cell over the second SS set is based at least in part on the linking of the second SS set with the third SS set; and communicating over the first cell based at least in part on the first control messages or the second control messages.

Aspect 2: The method of aspect 29, further comprising: suppressing monitoring of the first cell over the third SS set that is linked with the second SS set for cross-carrier scheduling based at least in part on the linking of the second SS set with the third SS set.

Aspect 3: The method of aspect 29, further comprising: monitoring the first cell over the third SS set that is linked with the second SS set for cross-carrier scheduling if a condition associated with the third SS set is satisfied; and suppressing monitoring of the first cell over the third SS set that is linked with the second SS set if the condition with the third SS set is not satisfied.

Aspect 4: The method of aspect 31, further comprising: receiving, via the at least one control message, an indication of a CORESET ID associated with the third SS set, wherein receiving the indication of the CORESET ID associated with the third SS set satisfies the condition.

Aspect 5: The method of any of aspects 31 or 32, further comprising: receiving, via the at least one control message, an indication of a type of the third SS set, wherein receiving the indication of the type of the third SS set satisfies the condition.

Aspect 6: The method of any of aspects 31 through 33, further comprising: receiving, via the at least one control message, a bitmap indicating a set of symbols during which to monitor over the third SS set, wherein receiving the bitmap indicating the set of symbols during which to monitor over the third SS set satisfies the condition.

Aspect 7: The method of aspect 29, further comprising: receiving, via the at least one control message, a parameter exclusively configured for indicating whether to monitor over the third SS set.

Aspect 8: The method of aspect 35, further comprising: monitoring the first cell over the third SS set that is linked with the second SS set for cross-carrier scheduling based at least in part the parameter indicating that the UE is to monitor over the third SS set; or suppressing monitoring of the first cell over the third SS set that is linked with the second SS set for cross-carrier scheduling based at least in part the parameter indicating that the UE is to refrain from monitoring over the third SS set.

Aspect 9: The method of any of aspects 29 through 36, wherein monitoring the second cell over the second SS set for the second control messages associated with scheduling of communication for the first cell comprises: monitoring over a quantity of PDCCH candidates based at least in part on the at least one control message identifying the third SS set with the quantity of PDCCH candidates and the linking of the second SS set with the third SS set.

Aspect 10: The method of any of aspects 29 through 37, wherein communicating on at least the first cell based at least in part on the first control messages or the second control messages comprises: receiving a downlink shared channel message based at least in part on scheduling information in the first control messages or the second control messages.

Aspect 11: The method of any of aspects 29 through 38, further comprising: receiving a control message indicating that the second cell is a scheduling cell for the first cell, wherein the first cell comprises a PCell or a PSCell and the second cell comprises an SCell.

Aspect 12: A method for wireless communication at a base station, comprising: transmitting, to a UE, at least one control message identifying a first SS set and a third SS set for a first cell and a second SS set for a second cell, wherein the third SS set for the first cell is linked, for cross-carrier scheduling of the first cell by the second cell, with the second SS set for the second cell; transmitting, to the UE on the first cell over the first SS set, first control messages associated with scheduling of communication for the first cell; transmitting, to the UE on the second cell over the second SS set, second control messages associated with scheduling of communication for the first cell, wherein transmitting the second control messages on the second cell over the second SS set is based at least in part on the linking of the second SS set with the third SS set; and communicating with the UE on at least the first cell based at least in part on the first control messages or the second control messages.

Aspect 13: The method of aspect 40, further comprising: suppressing transmitting control messages to the UE on the first cell over the third SS set that is linked with the second SS set for cross-carrier scheduling based at least in part on the linking of the second SS set with the third SS set.

Aspect 14: The method of aspect 40, further comprising: transmitting one or more control messages to the UE on the first cell over the third SS set that is linked with the second SS set for cross-carrier scheduling if a condition associated with the third SS set is satisfied; and suppressing transmitting the one or more control messages to the UE on the first cell over the third SS set that is linked with the second SS set for cross-carrier scheduling if the condition associated with the third SS set is not satisfied.

Aspect 15: The method of aspect 42, further comprising: transmitting, via the at least one control message, an indication of a CORESET ID associated with the third SS set, wherein transmitting the indication of the CORESET ID associated with the third SS set satisfies the condition.

Aspect 16: The method of any of aspects 42 or 43, further comprising: transmitting, via the at least one control message, an indication of a type of the third SS set, wherein transmitting the indication of the type of the third SS set satisfies the condition.

Aspect 17: The method of any of aspects 42 through 44, further comprising: transmitting, via the at least one control message, a bitmap indicating a set of symbols during which the UE is to monitor over the third SS set, wherein transmitting the bitmap indicating the set of symbols during which the UE is to monitor over the third SS set satisfies the condition.

Aspect 18: The method of aspect 40, further comprising: transmitting, via the at least one control message, a parameter exclusively configured for indicating whether the UE is to monitor over the third SS set.

Aspect 19: The method of aspect 18, further comprising: transmitting on the first cell over the third SS set that is linked with the second SS set for cross-carrier scheduling based at least in part the parameter indicating that the UE is to monitor over the third SS set; or suppressing transmitting on the first cell over the third SS set that is linked with the second SS set for cross-carrier scheduling based at least in part the parameter indicating that the UE is to refrain from monitoring over the third SS set.

Aspect 20: The method of any of aspects 40 through 19, wherein transmitting the second control messages to the UE on the second cell over the second SS set comprises: transmitting over at least a subset of a quantity of PDCCH candidates, the quantity of PDCCH candidates based at least in part on the at least one control message identifying the third SS set with the quantity of PDCCH candidates and the linking of the second SS set with the third SS set.

Aspect 21: The method of any of aspects 40 through 20, wherein communicating with the UE on at least the first cell based at least in part on the first control messages or the second control messages comprises: transmitting a downlink shared channel message based at least in part on scheduling information in the first control messages or the second control messages.

Aspect 22: The method of any of aspects 40 through 21, further comprising: transmitting a control message indicating that the second cell is a scheduling cell for the first cell, wherein the first cell comprises a PCell or a PSCell and the second cell comprises an SCell.

Aspect 23: An apparatus for wireless communication at a UE, comprising a processor; memory coupled with the processor; and instructions stored in the memory and executable by the processor to cause the apparatus to perform a method of any of aspects 29 through 39.

Aspect 24: An apparatus for wireless communication at a UE, comprising at least one means for performing a method of any of aspects 29 through 39.

Aspect 25: A non-transitory computer-readable medium storing code for wireless communication at a UE, the code comprising instructions executable by a processor to perform a method of any of aspects 29 through 39.

Aspect 26: An apparatus for wireless communication at a base station, comprising a processor; memory coupled with the processor; and instructions stored in the memory and executable by the processor to cause the apparatus to perform a method of any of aspects 40 through 22.

Aspect 27: An apparatus for wireless communication at a base station, comprising at least one means for performing a method of any of aspects 40 through 22.

Aspect 28: A non-transitory computer-readable medium storing code for wireless communication at a base station, the code comprising instructions executable by a processor to perform a method of any of aspects 40 through 22.

Aspect 29: A method for wireless communication at a UE, comprising: receiving one or more control messages identifying a first SS set for a first cell and a second SS set for a second cell, wherein the first SS set for the first cell is linked, for cross-carrier scheduling of the first cell by the second cell, with the second SS set for the second cell, and wherein the one or more control messages comprise a first parameter indicating whether to monitor for uplink grants, downlink grants, or both, for the first cell and comprise a second parameter indicating whether to monitor for uplink grants, downlink grants, or both, for the second cell; monitoring, based at least in part on the first parameter and the second parameter, the first cell over one of the first SS set or a third SS set for one of the uplink grants or the downlink grants and the second cell over the second SS set for the other one of the uplink grants or the downlink grants; and communicating over the first cell based at least in part on the uplink grants or the downlink grants, or both.

Aspect 30: The method of aspect 29, wherein the first parameter indicates a first subset of a set of control information formats for monitoring for the first SS set and the second parameter indicates a second subset of the set of control information formats for monitoring for the second SS set, and wherein the monitoring comprises: monitoring the first cell over the first SS set for the first subset of the set of control information formats and the second cell over the second SS set for the second subset of the set of control information formats.

Aspect 31: The method of aspect 29, wherein the first parameter indicates a first subset of a set of control information formats for monitoring for the third SS set and the second parameter indicates a second subset of the set of control information formats for monitoring for the second SS set, and wherein the monitoring comprises: monitoring the first cell over the third SS set for the first subset of the set of control information formats and the second cell over the second SS set for the second subset of the set of control information formats.

Aspect 32: The method of aspect 31, wherein a number of decoding candidates for monitoring for the second cell over the second SS set is indicated in a third parameter of a configuration for the first SS set.

Aspect 33: The method of any of aspects 29 through 32, wherein the first parameter indicates monitoring for the one of the uplink grants or the downlink grants for the first cell and the second parameter indicates monitoring for the other of the uplink grants or the downlink grants for the second cell, and wherein the monitoring comprises: monitoring the first cell over the first SS set for a first subset of a set of control information formats and the second cell over the second SS set for a second subset of the set of control information formats.

Aspect 34: The method of any of aspects 29 through 33, further comprising: transmitting, to a base station, an indication that a capability of the UE is associated with monitoring of the first cell for both the uplink grants and the downlink grants and the second cell for both the uplink grants and the downlink grants over non-overlapping monitoring occasions, wherein the monitoring comprises: monitoring the first cell over the first SS set for the one of the uplink grants or the downlink grants in a first set of monitoring occasions and the second cell over the second SS set for the other one of the uplink grants or the downlink grants in a second set of monitoring occasions, wherein the first set of monitoring occasions overlap in time with the second set of monitoring occasions.

Aspect 35: The method of any of aspects 29 through 34, wherein communicating on at least the first cell based at least in part on the uplink grants or the downlink grants, or both, comprises: transmitting an uplink data message based at least in part on first scheduling information in the uplink grants; and receiving a downlink data message based at least in part on second scheduling information in the downlink grants.

Aspect 36: The method of any of aspects 29 through 35, further comprising: receiving a control message indicating that the second cell is a scheduling cell for the first cell, wherein the first cell comprises a PCell or a PSCell and the second cell comprises an SCell.

Aspect 37: A method for wireless communication at a base station, comprising: transmitting, to a UE, one or more control messages identifying a first SS set for a first cell and a second SS set for a second cell, wherein the first SS set for the first cell is linked, for cross-carrier scheduling of the first cell by the second cell, with the second SS set for the second cell, and wherein the one or more control messages comprise a first parameter indicating whether to monitor for uplink grants, downlink grants, or both, for the first cell and comprise a second parameter indicating whether to monitor for uplink grants, downlink grants, or both, for the second cell; transmitting, to the UE on the first cell over one of the first SS set or a third SS set, one of the uplink grants or the downlink grants in accordance with the first parameter and, to the UE on the second cell over the second SS set, the other one of the uplink grants or the downlink grants in accordance with the second parameter; and communicating with the UE on at least the first cell based at least in part on the uplink grants or the downlink grants, or both.

Aspect 38: The method of aspect 37, wherein the first parameter indicates a first subset of a set of control information formats for transmission over the first SS set and the second parameter indicates a second subset of the set of control information formats for transmission over the second SS set, and wherein transmitting the one of the uplink grants or the downlink grants on the first cell and the other one of the uplink grants or the downlink grants on the second cell comprises: transmitting, on the first cell over the first SS set, first control information in accordance with the first subset of the set of control information formats and, on the second cell over the second SS set, second control information in accordance with the second subset of the set of control information formats.

Aspect 39: The method of aspect 37, wherein the first parameter indicates a first subset of a set of control information formats for transmission over the third SS set and the second parameter indicates a second subset of the set of control information formats for transmission over the second SS set, and wherein transmitting the one of the uplink grants or the downlink grants on the first cell and the other one of the uplink grants or the downlink grants on the second cell comprises: transmitting, on the first cell over the third SS set, first control information in accordance with the first subset of the set of control information formats and, on the second cell over the second SS set, second control information in accordance with the second subset of the set of control information formats.

Aspect 40: The method of aspect 39, wherein a number of decoding candidates for monitoring, by the UE, for the second cell over the second SS set is indicated in a third parameter of a configuration for the first SS set.

Aspect 41: The method of any of aspects 37 through 40, wherein the first parameter indicates transmission of the one of the uplink grants or the downlink grants for the first cell and the second parameter indicates transmission of the other of the uplink grants or the downlink grants for the second cell, and wherein transmitting the one of the uplink grants or the downlink grants on the first cell and the other one of the uplink grants or the downlink grants on the second cell comprises: transmitting, on the first cell over the first SS set, first control information in accordance with a first subset of a set of control information formats and, the second cell over the second SS set, second control information in accordance with a second subset of the set of control information formats.

Aspect 42: The method of any of aspects 37 through 41, further comprising: receiving, from the UE, an indication that a capability of the UE is associated with monitoring of the first cell for both the uplink grants and the downlink grants and the second cell for both the uplink grants and the downlink grants over non-overlapping monitoring occasions, and wherein transmitting the one of the uplink grants or the downlink grants on the first cell and the other one of the uplink grants or the downlink grants on the second cell comprises: transmitting, on the first cell over the first SS set, the one of the uplink grants or the downlink grants in a first set of monitoring occasions and, on the second cell over the second SS set, the other one of the uplink grants or the downlink grants in a second set of monitoring occasions, wherein the first set of monitoring occasions overlap in time with the second set of monitoring occasions.

Aspect 43: The method of any of aspects 37 through 42, wherein communicating with the UE on at least the first cell based at least in part on the uplink grants or the downlink grants, or both, comprises: receiving an uplink data message based at least in part on first scheduling information in the uplink grants; and transmitting a downlink data message based at least in part on second scheduling information in the downlink grants.

Aspect 44: The method of any of aspects 37 through 43, further comprising: transmitting a control message indicating that the second cell is a scheduling cell for the first cell, wherein the first cell comprises a PCell or a PSCell and the second cell comprises an SCell.

Aspect 45: An apparatus for wireless communication at a UE, comprising a processor; memory coupled with the processor; and instructions stored in the memory and executable by the processor to cause the apparatus to perform a method of any of aspects 29 through 36.

Aspect 46: An apparatus for wireless communication at a UE, comprising at least one means for performing a method of any of aspects 29 through 36.

Aspect 47: A non-transitory computer-readable medium storing code for wireless communication at a UE, the code comprising instructions executable by a processor to perform a method of any of aspects 29 through 36.

Aspect 48: An apparatus for wireless communication at a base station, comprising a processor; memory coupled with the processor; and instructions stored in the memory and executable by the processor to cause the apparatus to perform a method of any of aspects 37 through 44.

Aspect 49: An apparatus for wireless communication at a base station, comprising at least one means for performing a method of any of aspects 37 through 44.

Aspect 50: A non-transitory computer-readable medium storing code for wireless communication at a base station, the code comprising instructions executable by a processor to perform a method of any of aspects 37 through 44.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving at least one control message identifying a first search space set and a third search space set for a first cell and a second search space set for a second cell, wherein the third search space set for the first cell is linked, for cross-carrier scheduling of the first cell by the second cell, with the second search space set for the second cell;
monitoring the first cell over the first search space set for first control messages associated with scheduling of communication for the first cell;
monitoring the second cell over the second search space set for second control messages associated with scheduling of communication for the first cell, wherein monitoring the second cell over the second search space set is based at least in part on the linking of the second search space set with the third search space set; and
communicating over the first cell based at least in part on the first control messages or the second control messages.

2. The method of claim 1, further comprising:
suppressing monitoring of the first cell over the third search space set that is linked with the second search space set for cross-carrier scheduling based at least in part on the linking of the second search space set with the third search space set.

3. The method of claim 2, wherein receiving the at least one control message further comprises:
receiving an indication that the second search space set and the third search space set have a same search space identifier, wherein the linking between the second search space set with the third search space set is based at least in part on the second search space set and the third search space set having the same search space identifier, and wherein suppressing the monitoring of the first cell over the third search space set is based at least in part on the second search space set and the third search space set having the same search space identifier.

4. The method of claim 1, wherein monitoring the second cell over the second search space set for the second control messages associated with scheduling of communication for the first cell comprises:
monitoring over a quantity of physical downlink control channel (PDCCH) candidates based at least in part on the at least one control message identifying the third search space set with the quantity of PDCCH candidates and the linking of the second search space set with the third search space set.

5. The method of claim 1, further comprising:
monitoring the first cell over the third search space set that is linked with the second search space set for cross-carrier scheduling if a condition associated with the third search space set is satisfied; and
suppressing monitoring of the first cell over the third search space set that is linked with the second search space set if the condition with the third search space set is not satisfied.

6. The method of claim 1, further comprising:
receiving, via the at least one control message, a parameter exclusively configured for indicating whether to monitor over the third search space set.

7. The method of claim 6, further comprising:
monitoring the first cell over the third search space set that is linked with the second search space set for cross-carrier scheduling based at least in part on the parameter indicating that the UE is to monitor over the third search space set; or
suppressing monitoring of the first cell over the third search space set that is linked with the second search space set for cross-carrier scheduling based at least in part on the parameter indicating that the UE is to refrain from monitoring over the third search space set.

8. The method of claim 1, wherein communicating on at least the first cell based at least in part on the first control messages or the second control messages comprises:
receiving a downlink shared channel message based at least in part on scheduling information in the first control messages or the second control messages.

9. The method of claim 1, further comprising:
receiving a control message indicating that the second cell is a scheduling cell for the first cell, wherein the first cell comprises a primary cell (PCell) or a primary secondary cell (PSCell) and the second cell comprises a secondary cell (SCell).

10. A method for wireless communication at a network device, comprising:
transmitting, to a user equipment (UE), at least one control message identifying a first search space set and a third search space set for a first cell and a second search space set for a second cell, wherein the third search space set for the first cell is linked, for cross-carrier scheduling of the first cell by the second cell, with the second search space set for the second cell;
transmitting, to the UE on the first cell over the first search space set, first control messages associated with scheduling of communication for the first cell;
transmitting, to the UE on the second cell over the second search space set, second control messages associated with scheduling of communication for the first cell, wherein transmitting the second control messages on the second cell over the second search space set is based at least in part on the linking of the second search space set with the third search space set; and
communicating with the UE on at least the first cell based at least in part on the first control messages or the second control messages.

11. The method of claim 10, further comprising:
suppressing transmitting control messages to the UE on the first cell over the third search space set that is linked with the second search space set for cross-carrier scheduling based at least in part on the linking of the second search space set with the third search space set.

12. The method of claim 11, wherein receiving the at least one control message further comprises:
transmitting an indication that the second search space set and the third search space set have a same search space identifier, wherein the linking between the second search space set with the third search space set is based at least in part on the second search space set and the third search space set having the same search space identifier, and wherein suppressing the transmitting of the control messages on the first cell over the third search space set is based at least in part on the second search space set and the third search space set having the same search space identifier.

13. The method of claim 10, wherein transmitting the second control messages to the UE on the second cell over the second search space set comprises:
transmitting over at least a subset of a quantity of physical downlink control channel (PDCCH) candidates, the quantity of PDCCH candidates based at least in part on the at least one control message identifying the third search space set with the quantity of PDCCH candidates and the linking of the second search space set with the third search space set.

14. The method of claim 10, further comprising:
transmitting one or more control messages to the UE on the first cell over the third search space set that is linked with the second search space set for cross-carrier scheduling if a condition associated with the third search space set is satisfied; and
suppressing transmitting the one or more control messages to the UE on the first cell over the third search space set that is linked with the second search space set for cross-carrier scheduling if the condition associated with the third search space set is not satisfied.

15. The method of claim 10, further comprising:
transmitting, via the at least one control message, a parameter exclusively configured for indicating whether the UE is to monitor over the third search space set.

16. The method of claim 15, further comprising:
transmitting on the first cell over the third search space set that is linked with the second search space set for cross-carrier scheduling based at least in part on the parameter indicating that the UE is to monitor over the third search space set; or
suppressing transmitting on the first cell over the third search space set that is linked with the second search space set for cross-carrier scheduling based at least in part on the parameter indicating that the UE is to refrain from monitoring over the third search space set.

17. The method of claim 10, wherein communicating with the UE on at least the first cell based at least in part on the first control messages or the second control messages comprises:
transmitting a downlink shared channel message based at least in part on scheduling information in the first control messages or the second control messages.

18. The method of claim 10, further comprising:
transmitting a control message indicating that the second cell is a scheduling cell for the first cell, wherein the first cell comprises a primary cell (PCell) or a primary secondary cell (PSCell) and the second cell comprises a secondary cell (SCell).

19. An apparatus for wireless communication at a user equipment (UE), comprising:
a processor;
memory coupled with the processor; and
instructions stored in the memory and executable by the processor to cause the apparatus to:
receive at least one control message identifying a first search space set and a third search space set for a first cell and a second search space set for a second cell, wherein the third search space set for the first cell is linked, for cross-carrier scheduling of the first cell by the second cell, with the second search space set for the second cell;
monitor the first cell over the first search space set for first control messages associated with scheduling of communication for the first cell;
monitor the second cell over the second search space set for second control messages associated with scheduling of communication for the first cell, wherein monitoring the second cell over the second search space set is based at least in part on the linking of the second search space set with the third search space set; and
communicate over the first cell based at least in part on the first control messages or the second control messages.

20. The apparatus of claim 19, wherein the instructions are further executable by the processor to cause the apparatus to:
suppress monitoring of the first cell over the third search space set that is linked with the second search space set for cross-carrier scheduling based at least in part on the linking of the second search space set with the third search space set.

21. The apparatus of claim 20, wherein the instructions to receive the at least one control message are further executable to cause the apparatus to:
receive an indication that the second search space set and the third search space set have a same search space identifier, wherein the linking between the second search space set with the third search space set is based at least in part on the second search space set and the third search space set having the same search space identifier, and wherein suppressing the monitoring of the first cell over the third search space set is based at least in part on the second search space set and the third search space set having the same search space identifier.

22. The apparatus of claim 19, wherein the instructions to monitor the second cell over the second search space set for the second control messages associated with scheduling of communication for the first cell are executable by the processor to cause the apparatus to:
monitor over a quantity of physical downlink control channel (PDCCH) candidates based at least in part on the at least one control message identifying the third search space set with the quantity of PDCCH candidates and the linking of the second search space set with the third search space set.

23. The apparatus of claim 19, wherein the instructions are further executable by the processor to cause the apparatus to:
monitor the first cell over the third search space set that is linked with the second search space set for cross-carrier scheduling if a condition associated with the third search space set is satisfied; and
suppress monitoring of the first cell over the third search space set that is linked with the second search space set if the condition with the third search space set is not satisfied.

24. The apparatus of claim 19, wherein the instructions are further executable by the processor to cause the apparatus to:
receive, via the at least one control message, a parameter exclusively configured for indicating whether to monitor over the third search space set.

25. The apparatus of claim 24, wherein the instructions are further executable by the processor to cause the apparatus to:
monitor the first cell over the third search space set that is linked with the second search space set for cross-carrier scheduling based at least in part on the parameter indicating that the UE is to monitor over the third search space set; or
suppress monitoring of the first cell over the third search space set that is linked with the second search space set for cross-carrier scheduling based at least in part on the parameter indicating that the UE is to refrain from monitoring over the third search space set.

26. The apparatus of claim 19, wherein the instructions to communicate on at least the first cell based at least in part on the first control messages or the second control messages are executable by the processor to cause the apparatus to:
receive a downlink shared channel message based at least in part on scheduling information in the first control messages or the second control messages.

27. An apparatus for wireless communication at a network device, comprising:
a processor;
memory coupled with the processor; and
instructions stored in the memory and executable by the processor to cause the apparatus to:
transmit, to a user equipment (UE), at least one control message identifying a first search space set and a third search space set for a first cell and a second search space set for a second cell, wherein the third search space set for the first cell is linked, for cross-carrier scheduling of the first cell by the second cell, with the second search space set for the second cell;
transmit, to the UE on the first cell over the first search space set, first control messages associated with scheduling of communication for the first cell;
transmit, to the UE on the second cell over the second search space set, second control messages associated with scheduling of communication for the first cell, wherein transmitting the second control messages on the second cell over the second search space set is based at least in part on the linking of the second search space set with the third search space set; and
communicate with the UE on at least the first cell based at least in part on the first control messages or the second control messages.

28. The apparatus of claim 27, wherein the instructions are further executable by the processor to cause the apparatus to:
suppress transmitting control messages to the UE on the first cell over the third search space set that is linked with the second search space set for cross-carrier scheduling based at least in part on the linking of the second search space set with the third search space set.

29. The apparatus of claim 28, wherein receiving the at least one control message further comprises:
transmitting an indication that the second search space set and the third search space set have a same search space identifier, wherein the linking between the second search space set with the third search space set is based at least in part on the second search space set and the third search space set having the same search space identifier, and wherein suppressing the transmitting of the control messages on the first cell over the third search space set is based at least in part on the second search space set and the third search space set having the same search space identifier.

30. The apparatus of claim 27, wherein the instructions to transmit the second control messages to the UE on the second cell over the second search space set are executable by the processor to cause the apparatus to:
transmit over at least a subset of a quantity of physical downlink control channel (PDCCH) candidates, the quantity of PDCCH candidates based at least in part on the at least one control message identifying the third search space set with the quantity of PDCCH candidates and the linking of the second search space set with the third search space set.
